(19) United States
(12) Patent Application Publication
(10) Pub. No.: US 2015/0160437 A1
(43) Pub. Date: Jun. 11, 2015

(54) OPTICAL IMAGING LENS AND ELECTRONIC DEVICE COMPRISING THE SAME

(71) Applicants: Kai Lun Wang, Taichung City (TW); Ta-Cheng Fan, Taichung City (TW); Jia-Sin Jhang, Taichung City (TW)

(72) Inventors: Kai Lun Wang, Taichung City (TW); Ta-Cheng Fan, Taichung City (TW); Jia-Sin Jhang, Taichung City (TW)

(21) Appl. No.: 14/289,660

(22) Filed: May 29, 2014

(30) Foreign Application Priority Data
Dec. 9, 2013 (CN) 201310662070.9

(51) Int. Cl. G02B 13/00; H04N 5/225

(52) U.S. Cl. CPC G02B 13/0015; H04N 5/2252; H04N 5/2254

(57) ABSTRACT

An optical imaging lens set includes a first lens with positive refractive power, a convex object-side surface and a convex image-side surface in a vicinity of its periphery, a second lens element with negative refractive power and a concave object-side surface in a vicinity of its periphery, a third lens element with positive refractive power, a concave object-side surface in a vicinity of the optical axis and a convex image-side surface in a vicinity of the optical axis, a fourth lens element with a convex object-side surface in a vicinity of the optical axis, a concave image-side surface in a vicinity of the optical axis and a convex image-side surface in a vicinity of its periphery. G₁₂ is an air gap between the first and the second lens, and G₂₃ is an air gap between the second and the third lens to satisfy 0.5≦G₁₂/G₂₃≦3.0.

### CROSS REFERENCE TO RELATED APPLICATION

This application claims priority to China Application No. 201310662070.9, filed on Dec. 9, 2013.

### BACKGROUND OF THE INVENTION

1. Field of the Invention

The present invention generally relates to an optical imaging lens set and an electronic device which includes such optical imaging lens set. Specifically speaking, the present invention is directed to an optical imaging lens set of reduced length and an electronic device which includes such optical imaging lens set.

2. Description of the Prior Art

In recent years, the popularity of mobile phones and digital cameras makes the photography modules of various portable electronic products, such as optical imaging lens elements, holders or an image sensor . . . develop quickly, and the shrinkage of mobile phones and digital cameras also makes a greater and greater demand for the miniaturization of the photography module. The current trend of research is to develop an optical imaging lens set of a shorter length with uncompromised good quality.

With the development and shrinkage of a charge coupled device (CCD) or a complementary metal oxide semiconductor element (CMOS), the optical imaging lens set installed in the photography module shrinks as well to meet the demands. However, good and necessary optical properties, such as the system aberration improvement, as well as production cost and production feasibility should be taken into consideration, too.

An optical imaging lens set made of four lens elements is known. For example, US 2011/0299178 discloses an optical imaging lens set made of four lens elements. Its first lens element has negative refractive power and both the object-side surface and the image-side surface are concave. The second lens element has positive refractive power and both the object-side surface and the image-side surface are convex. However, the total length of the optical imaging lens set is designed up to 18-19 mm so it is not small and optically ideal.

Further, US 2011/0242683, U.S. Pat. No. 8,270,097, U.S. Pat. No. 8,379,326 all disclose another optical imaging lens sets made of four lens elements. Both the first lens element and the second lens element have negative refractive power and the gap between the first lens element and the second lens element is quite large so the total length of the optical imaging lens set is not short enough.

These disclosed dimensions do not show good examples of the shrinkage of portable electronic products, such as mobile phones and digital cameras. It is still a problem, on one hand, to reduce the system length efficiently and, on the other hand, to maintain a sufficient optical performance in this field.

### SUMMARY OF THE INVENTION

In the light of the above, the present invention is capable of proposing an optical imaging lens set of lightweight, low production cost, reduced length, high resolution and high image quality. The optical imaging lens set of four lens elements of the present invention has an aperture stop, a first lens element, a second lens element, a third lens element, and a fourth lens element sequentially from an object side to an image side along an optical axis. Each lens element has certain refractive power and the optical imaging lens set exclusively has four lens elements with refractive power.

The first lens element has positive refractive power, a first object-side surface facing toward the object side and a first image-side surface facing toward the image side. The first image-side surface has a convex portion in a vicinity of a circular periphery of the first lens element. The second lens element has negative refractive power and a second object-side surface facing toward the object-side. The second object-side surface has a concave portion in a vicinity of a circular periphery of the second lens element. The third lens element has positive refractive power, a third object-side surface facing toward the object side and a third image-side surface facing toward the image side. The third object-side surface has a concave portion in a vicinity of the optical axis and the third image-side surface has a convex portion in a vicinity of the optical axis. The fourth lens element has a fourth object-side surface facing toward the object side and a fourth image-side surface facing toward the image side. The fourth object-side surface has a convex portion in a vicinity of the optical axis. The fourth image-side surface has a concave portion in a vicinity of the optical axis and a convex portion in a vicinity of a circular periphery of the fourth lens element.

The optical imaging lens set exclusively has four lens elements with refractive power. An air gap G₁₂ is between the first lens element and the second lens element along the optical axis. An air gap G₂₃ is between the second lens element and the third lens element along the optical axis. An air gap G₃₄ is between the third lens element and the fourth lens element along the optical axis. All air gaps Gₐₐ is a sum of three air gaps between each lens element from the first lens element to the fourth lens element along the optical axis. A thickness of the first lens element along the optical axis is T₁. A thickness of the second lens element along the optical axis is T₂. A thickness of the third lens element along the optical axis is T₃ and a thickness of the fourth lens element along the optical axis is T₄. A total thickness of the first lens element, the second lens element, the third lens element and the fourth lens element along the optical axis is Tₐₗₗ. A back focal length from the fourth image-side surface to an image plane along the optical axis is BFL. They satisfy 0.5≦(G₁₂/G₂₃)≦3.0.

In the optical imaging lens set of four lens elements of the present invention, the optical imaging lens set satisfies (T₃/T₄)≦1.65.

In the optical imaging lens set of four lens elements of the present invention, the optical imaging lens set satisfies 5.6 (BFL/G₂₃).

In the optical imaging lens set of four lens elements of the present invention, the optical imaging lens set satisfies (T₄/G₂₃)≦7.

In the optical imaging lens set of four lens elements of the present invention, the optical imaging lens set satisfies 2.6≦(BFL/T₄).

In the optical imaging lens set of four lens elements of the present invention, the optical imaging lens set satisfies (Tₐₗₗ/G₂₃)≦9.5.

In the optical imaging lens set of four lens elements of the present invention, the optical imaging lens set satisfies (T₃/Gₐₐ)≦1.2.

In the optical imaging lens set of four lens elements of the present invention, the optical imaging lens set satisfies (BFL/G₃₄)≦18.

In the optical imaging lens set of four lens elements of the present invention, the optical imaging lens set satisfies 5.6≦(BFL/G₁₂).

In the optical imaging lens set of four lens elements of the present invention, the optical imaging lens set satisfies 1.1≦(T₃/T₁).

In the optical imaging lens set of four lens elements of the present invention, the optical imaging lens set satisfies (T₁/T₄)≦1.45.

In the optical imaging lens set of four lens elements of the present invention, the optical imaging lens set satisfies (T₂/G₁₂)≦1.78.

In the optical imaging lens set of four lens elements of the present invention, the optical imaging lens set satisfies 1.6≦(T₁/T₂).

The present invention also proposes an electronic device which includes the optical imaging lens set as described above. The electronic device includes a case and an image module disposed in the case. The image module includes an optical imaging lens set as described above, a barrel for the installation of the optical imaging lens set, a module housing unit for the installation of the barrel, a substrate for the installation of the module housing unit and an image sensor disposed at the substrate and at an image side of the optical imaging lens set.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 illustrates a first example of the optical imaging lens set of the present invention.

FIG. 2A illustrates the longitudinal spherical aberration on the image plane of the first example.

FIG. 2B illustrates the astigmatic aberration on the sagittal direction of the first example.

FIG. 2C illustrates the astigmatic aberration on the tangential direction of the first example.

FIG. 2D illustrates the distortion aberration of the first example.

FIG. 3 illustrates a second example of the optical imaging lens set of four lens elements of the present invention.

FIG. 4A illustrates the longitudinal spherical aberration on the image plane of the second example.

FIG. 4B illustrates the astigmatic aberration on the sagittal direction of the second example.

FIG. 4C illustrates the astigmatic aberration on the tangential direction of the second example.

FIG. 4D illustrates the distortion aberration of the second example.

FIG. 5 illustrates a third example of the optical imaging lens set of four lens elements of the present invention.

FIG. 6A illustrates the longitudinal spherical aberration on the image plane of the third example.

FIG. 6B illustrates the astigmatic aberration on the sagittal direction of the third example.

FIG. 6C illustrates the astigmatic aberration on the tangential direction of the third example.

FIG. 6D illustrates the distortion aberration of the third example.

FIG. 7 illustrates a fourth example of the optical imaging lens set of four lens elements of the present invention.

FIG. 8A illustrates the longitudinal spherical aberration on the image plane of the fourth example.

FIG. 8B illustrates the astigmatic aberration on the sagittal direction of the fourth example.

FIG. 8C illustrates the astigmatic aberration on the tangential direction of the fourth example.

FIG. 8D illustrates the distortion aberration of the fourth example.

FIG. 9 illustrates a fifth example of the optical imaging lens set of four lens elements of the present invention.

FIG. 10A illustrates the longitudinal spherical aberration on the image plane of the fifth example.

FIG. 10B illustrates the astigmatic aberration on the sagittal direction of the fifth example.

FIG. 10C illustrates the astigmatic aberration on the tangential direction of the fifth example.

FIG. 10D illustrates the distortion aberration of the fifth example.

FIG. 11 illustrates a sixth example of the optical imaging lens set of four lens elements of the present invention.

FIG. 12A illustrates the longitudinal spherical aberration on the image plane of the sixth example.

FIG. 12B illustrates the astigmatic aberration on the sagittal direction of the sixth example.

FIG. 12C illustrates the astigmatic aberration on the tangential direction of the sixth example.

FIG. 12D illustrates the distortion aberration of the sixth example.

FIG. 13 illustrates a seventh example of the optical imaging lens set of four lens elements of the present invention.

FIG. 14A illustrates the longitudinal spherical aberration on the image plane of the seventh example.

FIG. 14B illustrates the astigmatic aberration on the sagittal direction of the seventh example.

FIG. 14C illustrates the astigmatic aberration on the tangential direction of the seventh example.

FIG. 14D illustrates the distortion aberration of the seventh example.

FIG. 15 illustrates a eighth example of the optical imaging lens set of four lens elements of the present invention.

FIG. 16A illustrates the longitudinal spherical aberration on the image plane of the eighth example.

FIG. 16B illustrates the astigmatic aberration on the sagittal direction of the seventh example.

FIG. 16C illustrates the astigmatic aberration on the tangential direction of the eighth example.

FIG. 16D illustrates the distortion aberration of the eighth example.

FIG. 17 illustrates a ninth example of the optical imaging lens set of four lens elements of the present invention.

FIG. 18A illustrates the longitudinal spherical aberration on the image plane of the ninth example.

FIG. 18B illustrates the astigmatic aberration on the sagittal direction of the ninth example.

FIG. 18C illustrates the astigmatic aberration on the tangential direction of the ninth example.

FIG. 18D illustrates the distortion aberration of the ninth example.

FIG. 19 illustrates exemplificative shapes of the optical imaging lens element of the present invention.

FIG. 20 illustrates a first preferred example of the portable electronic device with an optical imaging lens set of the present invention.

FIG. 21 illustrates a second preferred example of the portable electronic device with an optical imaging lens set of the present invention.

FIG. 22 shows the optical data of the first example of the optical imaging lens set.

FIG. 23 shows the aspheric surface data of the first example.

FIG. 24 shows the optical data of the second example of the optical imaging lens set.

FIG. 25 shows the aspheric surface data of the second example.

FIG. 26 shows the optical data of the third example of the optical imaging lens set.

FIG. 27 shows the aspheric surface data of the third example.

FIG. 28 shows the optical data of the fourth example of the optical imaging lens set.

FIG. 29 shows the aspheric surface data of the fourth example.

FIG. 30 shows the optical data of the fifth example of the optical imaging lens set.

FIG. 31 shows the aspheric surface data of the fifth example.

FIG. 32 shows the optical data of the sixth example of the optical imaging lens set.

FIG. 33 shows the aspheric surface data of the sixth example.

FIG. 34 shows the optical data of the seventh example of the optical imaging lens set.

FIG. 35 shows the aspheric surface data of the seventh example.

FIG. 36 shows the optical data of the eighth example of the optical imaging lens set.

FIG. 37 shows the aspheric surface data of the eighth example.

FIG. 38 shows the optical data of the ninth example of the optical imaging lens set.

FIG. 39 shows the aspheric surface data of the ninth example.

FIG. 40 shows some important ratios in the examples.

### DETAILED DESCRIPTION

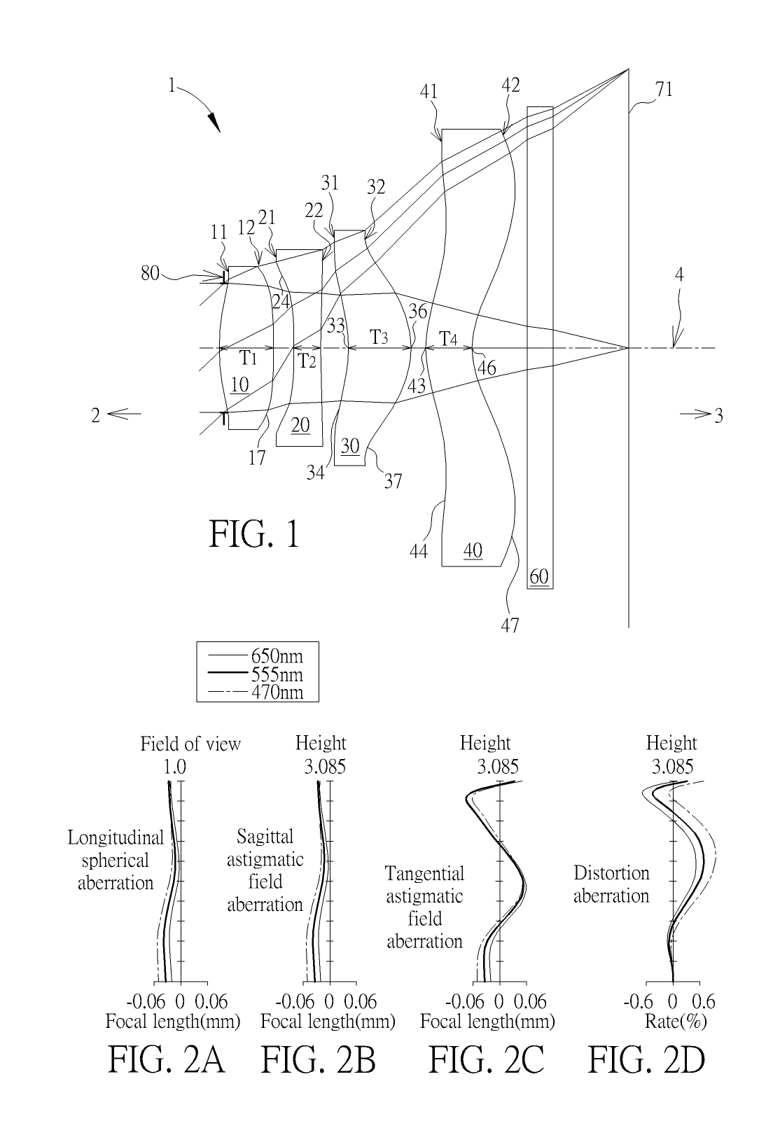

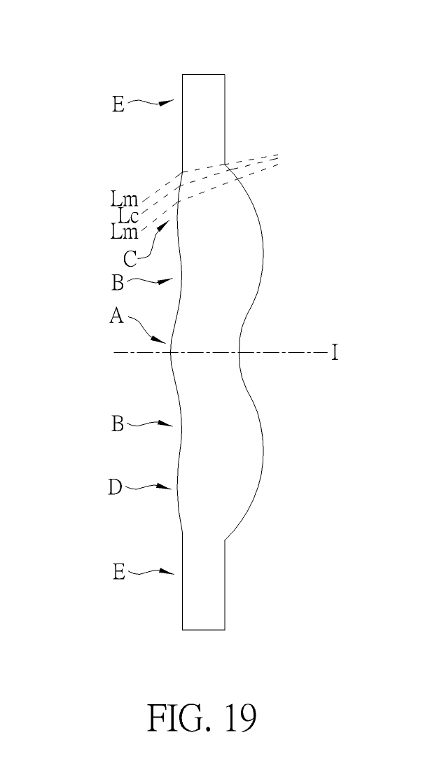

Before the detailed description of the present invention, the first thing to be noticed is that in the present invention, similar (not necessarily identical) elements share the same numeral references. In the entire present specification, “a certain lens element has negative/positive refractive power” refers to the part in a vicinity of the optical axis of the lens element has negative/positive refractive power. “An object-side/image-side surface of a certain lens element has a concave/convex part or concave/convex portion” refers to the part is more concave/convex in a direction parallel with the optical axis to be compared with an outer region next to the region. Take FIG. 19 for example, the optical axis is “I” and the lens element is symmetrical with respect to the optical axis I. The object side of the lens element has a convex part in the region A, a concave part in the region B, and a convex part in the region C because region A is more convex in a direction parallel with the optical axis than an outer region (region B) next to region A, region B is more concave than region C and region C is similarly more convex than region E. “A circular periphery of a certain lens element” refers to a circular periphery region of a surface on the lens element for light to pass through, that is, region C in the drawing. In the drawing, imaging light includes Lc (chief ray) and Lm (marginal ray). “A vicinity of the optical axis” refers to an optical axis region of a surface on the lens element for light to pass through, that is, the region A in FIG. 19. In addition, the lens element may include an extension part E for the lens element to be installed in an optical imaging lens set. Ideally speaking, no light would pass through the extension part, and the actual structure and shape of the extension part is not limited to this and may have other variations. For the reason of simplicity, the extension part is not illustrated in FIGS. 1, 3, 5, 7, 9, 11, 13, 15 and 17.

As shown in FIG. 1, the optical imaging lens set 1 of four lens elements of the present invention, sequentially from an object side 2 (where an object is located) to an image side 3 along an optical axis 4, has a first lens element 10, a second lens element 20, a third lens element 30, a fourth lens element 40, a filter 60 and an image plane 71. Generally speaking, the first lens element 10, the second lens element 20, the third lens element 30 and the fourth lens element 40 may be made of a transparent plastic material and each has an appropriate refractive power, but the present invention is not limited to this and there are exclusively four lens elements with refractive power in the optical imaging lens set 1 of the present invention. The optical axis 4 is the optical axis of the entire optical imaging lens set 1, and the optical axis of each of the lens elements coincides with the optical axis of the optical imaging lens set 1.

Furthermore, the optical imaging lens set 1 includes an aperture stop (ape. stop) 80 disposed in an appropriate position. In FIG. 1, the aperture stop 80 is disposed in front of the first lens element 10 and between the first lens element 10 and the object side 2. When light emitted or reflected by an object (not shown) which is located at the object side 2 enters the optical imaging lens set 1 of the present invention, it forms a clear and sharp image on the image plane 71 at the image side 3 after passing through the aperture stop 80, the first lens element 10, the second lens element 20, the third lens element 30, the fourth lens element 40 and the filter 60.

In the embodiments of the present invention, the optional filter 60 may be a filter of various suitable functions, for example, the filter 60 may be an infrared cut filter (IR cut filter), placed between the fourth lens element 40 and the image plane 71.

Each lens element in the optical imaging lens set 1 of the present invention has an object-side surface facing toward the object side 2 as well as an image-side surface facing toward the image side 3. In addition, each object-side surface and image-side surface in the optical imaging lens set 1 of the present invention has a part in a vicinity of its circular periphery (circular periphery part) away from the optical axis 4 as well as a part in a vicinity of the optical axis (optical axis part) closer to the optical axis 4. For example, the first lens element 10 has an object-side surface 11 and an image-side surface 12; the second lens element 20 has an object-side surface 21 and an image-side surface 22; the third lens element 30 has an object-side surface 31 and an image-side surface 32; the fourth lens element 40 has an object-side surface 41 and an image-side surface 42.

Each lens element in the optical imaging lens set 1 of the present invention further has a central thickness T on the optical axis 4. For example, the first lens element 10 has a first lens element thickness T₁, the second lens element 20 has a second lens element thickness T₂, the third lens element 30 has a third lens element thickness T₃ and the fourth lens element 40 has a fourth lens element thickness T₄. Therefore, the total thickness of all the lens elements in the optical imaging lens set 1 along the optical axis 4 is Tₐₗ. Tₐₗ=T₁+T₂+T₃+T₄.

In addition, between two adjacent lens elements in the optical imaging lens set 1 of the present invention there is an air gap G along the optical axis 4. For example, an air gap G₁₂ is disposed between the first lens element 10 and the second lens element 20, an air gap G₂₃ is disposed between the second lens element 20 and the third lens element 30 and an air gap G₃₄ is disposed between the third lens element 30 and the fourth lens element 40. Therefore, the sum of total three air gaps between adjacent lens elements from the first lens element 10 to the fourth lens element 40 along the optical axis 4 is Gₐₐ. Gₐₐ=G₁₂+G₂₃+G₃₄.

### First Example

Please refer to FIG. 1 which illustrates the first example of the optical imaging lens set 1 of the present invention. Please refer to FIG. 2A for the longitudinal spherical aberration on the image plane 71 of the first example; please refer to FIG. 2B for the astigmatic field aberration on the sagittal direction; please refer to FIG. 2C for the astigmatic field aberration on the tangential direction, and please refer to FIG. 2D for the distortion aberration. The Y axis of the spherical aberration in each example is “field of view” for 1.0. The Y axis of the astigmatic field and the distortion in each example stands for “image height”.

The optical imaging lens set 1 of the first example has four lens elements 10 to 40; each is made of a plastic material and has refractive power. The optical imaging lens set 1 also has a filter 60, an aperture stop 80, and an image plane 71. The aperture stop 80 is provided between the first lens element 10 and the object side 2. The filter 60 may be an infrared filter (IR cut filter) to prevent inevitable infrared in light reaching the image plane to adversely affect the imaging quality.

The first lens element 10 has positive refractive power. The object-side surface 11 of the first lens element 10 facing toward the object side 2 is a convex surface. The image-side surface 12 of the first lens element 10 facing toward the image side 3 is also a convex surface and has a convex portion 17 (convex circular periphery part) in a vicinity of its circular periphery. Both the object-side surface 11 and the image-side 12 of the first lens element 10 are aspherical surfaces.

The second lens element 20 has negative refractive power. The object-side surface 21 of the second lens element 20 facing toward the object side 2 is a concave surface and has a concave portion 24 (concave circular periphery part) in a vicinity of its circular periphery. The image-side surface 22 of the second lens element 20 facing toward the image side 3 is also a concave surface. In addition, both the object-side surface 21 and the image-side surface 22 of the second lens element 20 are aspherical surfaces.

The third lens element 30 has positive refractive power, an object-side surface 31 of the third lens element 30 facing toward the object side 2 and an image-side surface 32 of the third lens element 30 facing toward the image side 3. The object-side surface 31 has a concave portion 33 (concave optical axis part) in a vicinity of the optical axis and convex portion 34 (convex circular periphery part) in a vicinity of its circular periphery. The third image-side surface 32 has a convex portion 36 in a vicinity of the optical axis and a concave portion 37 (concave circular periphery part) in a vicinity of its circular periphery. In addition, both the object-side surface 31 and the mage-side surface 32 of the third lens element 30 are aspherical surfaces.

The fourth lens element 40 has negative refractive power. The object-side surface 41 of the fourth lens element 40 facing toward the object side 2 has a convex part 43 (convex optical axis part) in the vicinity of the optical axis and a concave part 44 (concave circular periphery part) in a vicinity of its circular periphery. The image-side surface 42 of the fourth lens element 40 facing toward the image side 2 has a concave part 46 in the vicinity of the optical axis and a convex part 47 in a vicinity of its circular periphery. In addition, both the object-side surface 41 and the image-side 42 of the fourth lens element 40 are aspherical surfaces. The filter 60 may be an infrared filter (IR cut filter) and disposed between the fourth lens element 40 and the image plane 71.

In the optical imaging lens element 1 of the present invention, the object side 11/21/31/41 and image side 12/22/32/42 from the first lens element 10 to the fourth lens element 40, total of eight surfaces are all aspherical. These aspheric coefficients are defined according to the following formula:

$$Z ( Y ) = \frac{{Y}^{2}}{R} / ( 1 + \sqrt{1 - ( 1 + K ) \frac{{Y}^{2}}{{R}^{2}}} ) + {\sum }_{i = 1}^{n} {a}_{2 i} \times {Y}^{2 i}$$

In which:

R represents the curvature radius of the lens element surface;

Z represents the depth of an aspherical surface (the perpendicular distance between the point of the aspherical surface at a distance Y from the optical axis and the tangent plane of the vertex on the optical axis of the aspherical surface);

Y represents a vertical distance from a point on the aspherical surface to the optical axis;

K is a conic constant;

a₂ᵢ is the aspheric coefficient of the 2i order.

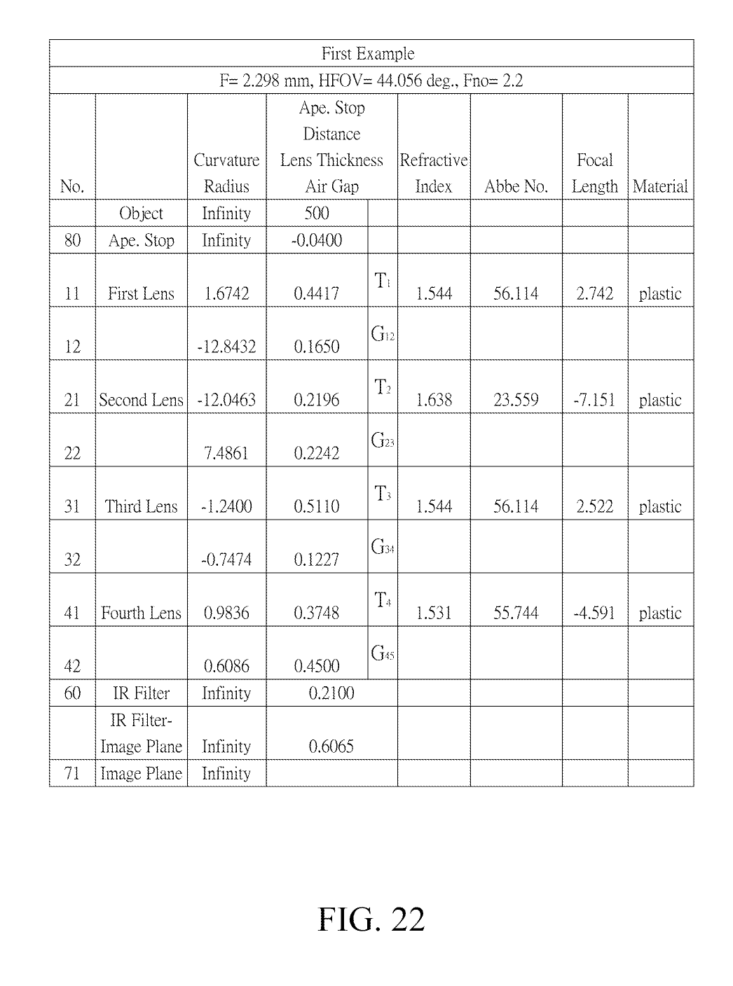

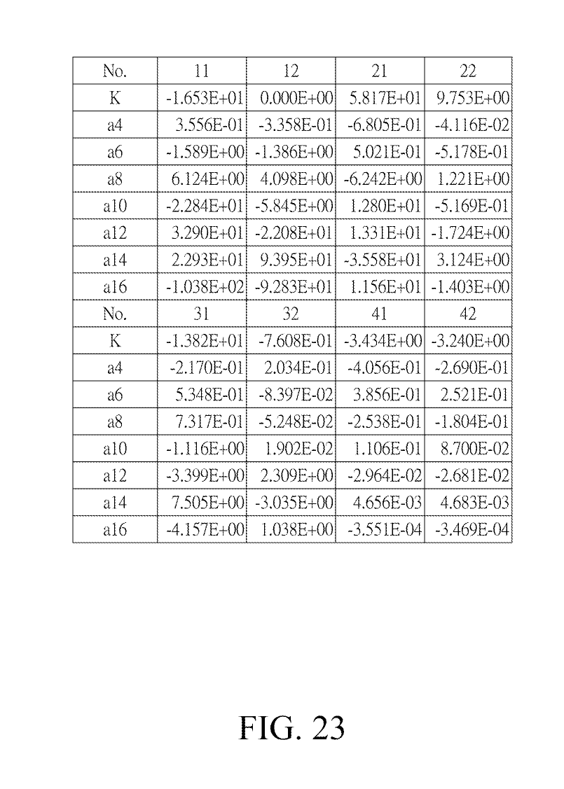

The optical data of the first example of the optical imaging lens set 1 are shown in FIG. 22 while the aspheric surface data are shown in FIG. 23. In the following examples of the optical imaging lens set, the f-number of the entire optical lens element system is Fno, HFOV stands for the half field of view which is half of the field of view of the entire optical lens element system, and the unit for the curvature radius, the thickness and the focal length is in millimeters (mm), and EFL is a system focal length of the optical imaging lens set 1. The length of the optical imaging lens set is 3.325 mm (from the first object-side surface to the image plane along the optical axis). The image height is 2.270 mm. Some important ratios of the first example are as follows:

### Tₐₗₗ=1.547

### Gₐₐ=0.512

### BFL=1.267

(G₁₂/G₂₃)=0.736 (satisfies the condition of 0.5˜3.0)
(T₃/T₄)=1.363 (satisfies the condition of less than 1.65)
(BFL/G₂₃)=5.650 (satisfies the condition of greater than 5.6)
(T₄/G₂₃)=1.672 (satisfies the condition of less than 7.0)
(T₃/Gₐₐ)=0.998 (satisfies the condition of less than 1.2)
(BFL/T₄)=3.379 (satisfies the condition of greater than 2.6)
(Tₐₗₗ/G₂₃)=6.901 (satisfies the condition of less than 9.5)
(BFL/G₃₄)=10.319 (satisfies the condition of less than 18.0)
(BFL/G₁₂)=7.674 (satisfies the condition of greater than 5.6)
(T₃/T₁)=1.157 (satisfies the condition of greater than 1.1)
(T₁/T₄)=1.178 (satisfies the condition of less than 1.45)
(T₂/G₁₂)=1.330 (satisfies the condition of less than 1.78)
(T₁/T₂)=2.012 (satisfies the condition of greater than 1.6)

### Second Example

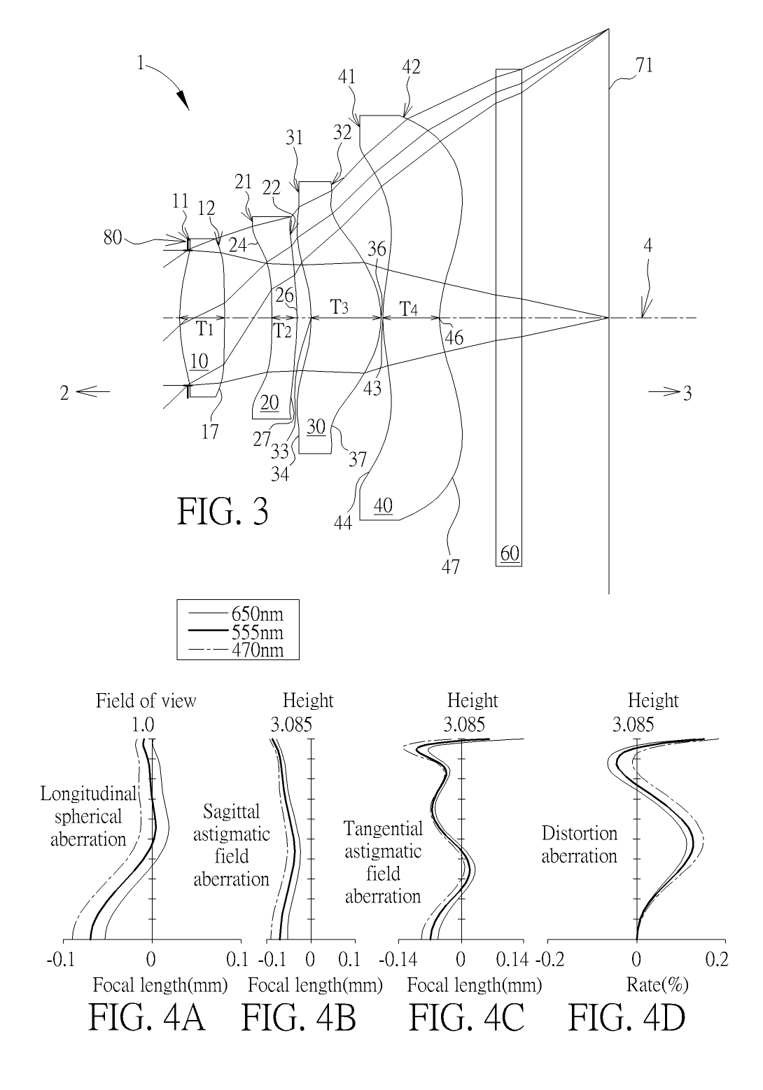

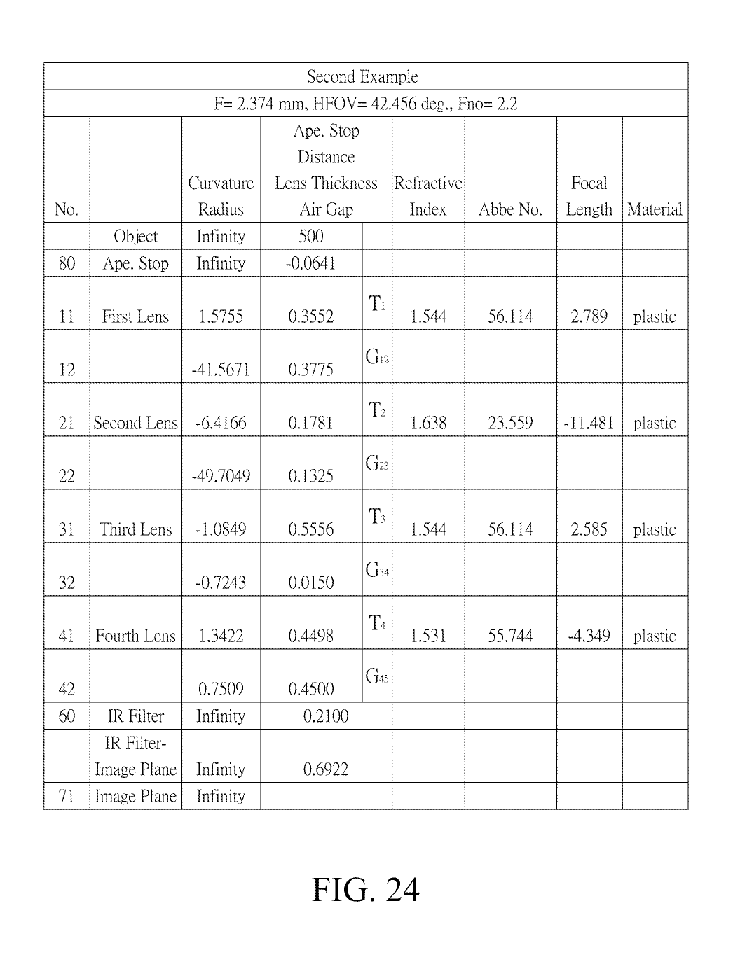

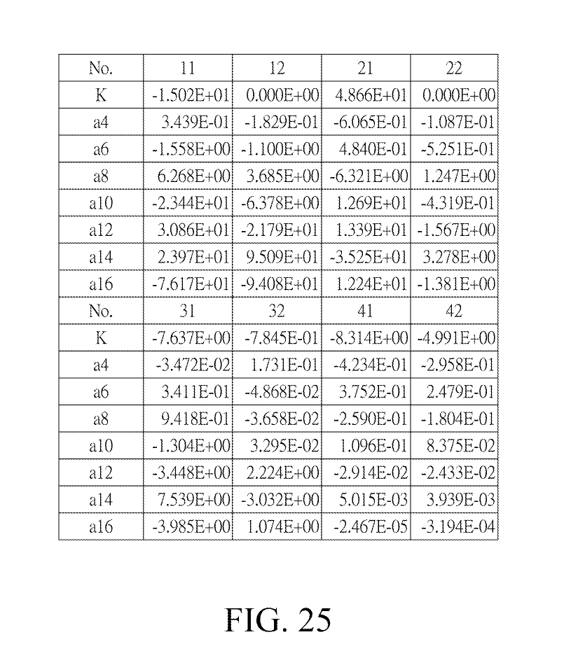

Please refer to FIG. 3 which illustrates the second example of the optical imaging lens set 1 of the present invention. Please refer to FIG. 4A for the longitudinal spherical aberration on the image plane 71 of the second example; please refer to FIG. 4B for the astigmatic aberration on the sagittal direction; please refer to FIG. 4C for the astigmatic aberration on the tangential direction, and please refer to FIG. 4D for the distortion aberration. The second example is similar with the first example except: the image-side surface 22 of the second lens element 20 has a convex portion 26 (convex optical axis part) in a vicinity of the optical axis and a concave portion 27 (concave circular periphery part) in a vicinity of its circular periphery. The optical data of the second example of the optical imaging lens set are shown in FIG. 24 while the aspheric surface data are shown in FIG. 25. The length of the optical imaging lens set is 3.416 mm. The image height is 2.27 mm. Some important ratios of the second example are as follows:

### Tₐₗₗ=1.539

### Gₐₐ=0.525

### BFL=1.352

### (G₁₂/G₂₃)=2.848

### (T₃/T₄)=1.235

### (BFL/G₂₃)=10.204

### (T₄/G₂₃)=3.394

### (T₃/Gₐₐ)=1.058

### (BFL/T₄)=3.006

### (Tₐₗₗ/G₂₃)=11.611

### (BFL/G₃₄)=90.331

### (BFL/G₁₂)=3.582

### (T₃/T₁)=1.564

### (T₁/T₄)=0.790

### (T₂/G₁₂)=0.472

### (T₁/T₂)=1.995

### Third Example

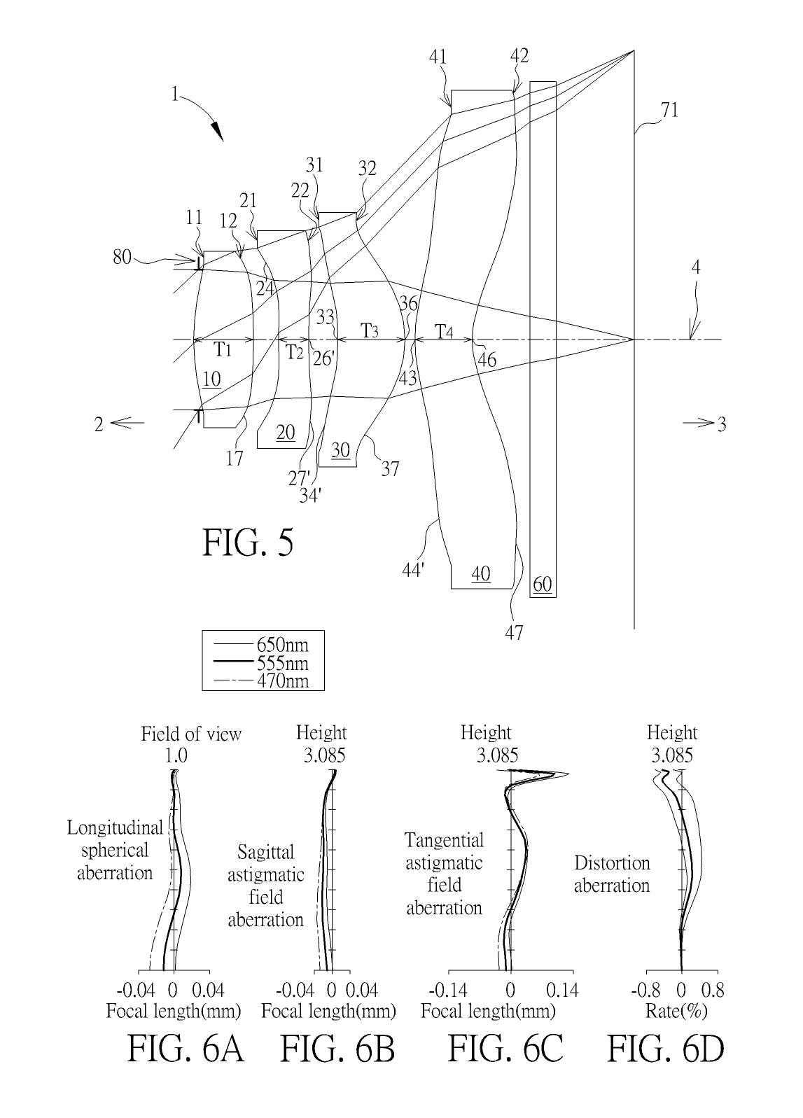

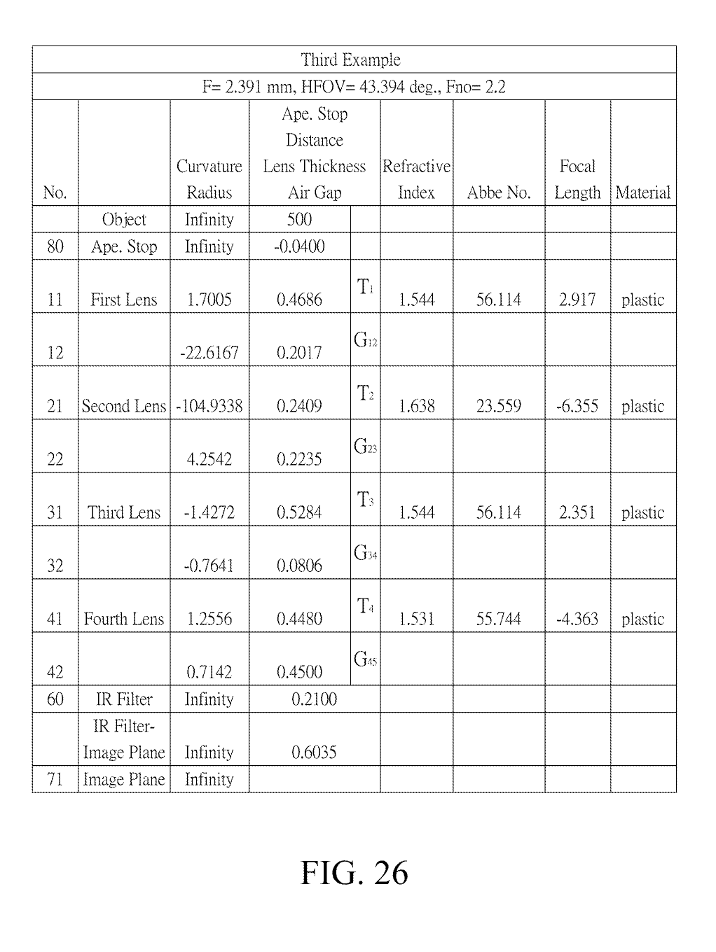

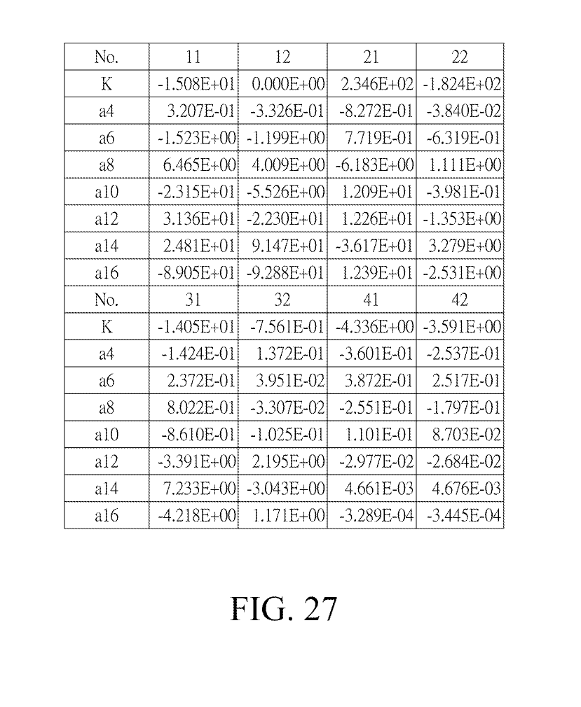

Please refer to FIG. 5 which illustrates the third example of the optical imaging lens set 1 of the present invention. Please refer to FIG. 6A for the longitudinal spherical aberration on the image plane 71 of the second example; please refer to FIG. 6B for the astigmatic aberration on the sagittal direction; please refer to FIG. 6C for the astigmatic aberration on the tangential direction, and please refer to FIG. 6D for the distortion aberration. The third example is similar with the first example except: the image-side surface 22 of the second lens element 20 has a concave part 26′ (concave optical axis part) in the vicinity of the optical axis and a convex part 27′ (convex circular periphery part) in a vicinity of its circular periphery, the object-side surface 31 of the third lens element 30 is a concave surface and has a concave portion 34′ (concave circular periphery part) in a vicinity of its circular periphery, and the object-side surface 41 of the fourth lens element 40 is a convex surface and has a convex part 44′ (convex circular periphery part) in a vicinity of its circular periphery. The optical data of the third example of the optical imaging lens set are shown in FIG. 26 while the aspheric surface data are shown in FIG. 27. The length of the optical imaging lens set is 3.455 mm. The image height is 2.270 mm. Some important ratios of the third example are as follows:

### Tₐₗₗ=1.686

### Gₐₐ=0.506

### BFL=1.264

### (G₁₂/G₂₃)=0.903

### (T₃/T₄)=1.180

### (BFL/G₂₃)=5.654

### (T₄/G₂₃)=2.005

### (T₃/Gₐₐ)=1.045

### (BFL/T₄)=2.820

### (Tₐₗₗ/G₂₃)=7.545

### (BFL/G₃₄)=15.680

### (BFL/G₁₂)=6.263

### (T₃/T₁)=1.128

### (T₁/T₄)=1.046

### (T₂/G₁₂)=1.194

### (T₁/T₂)=1.945

### Fourth Example

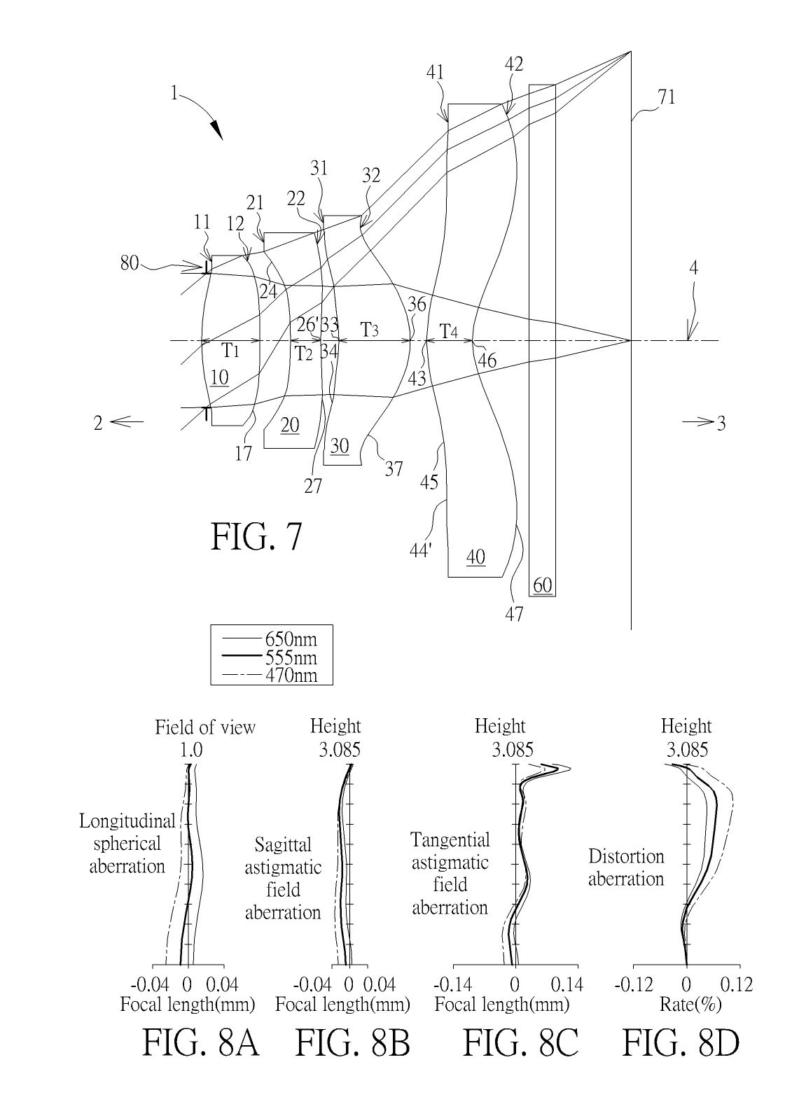

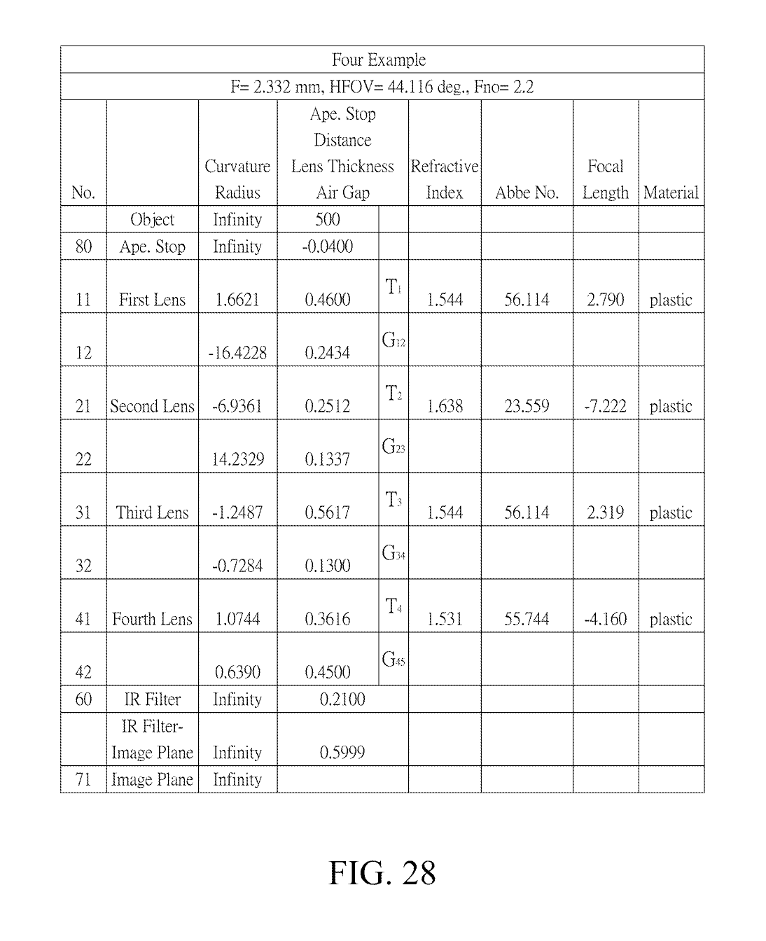

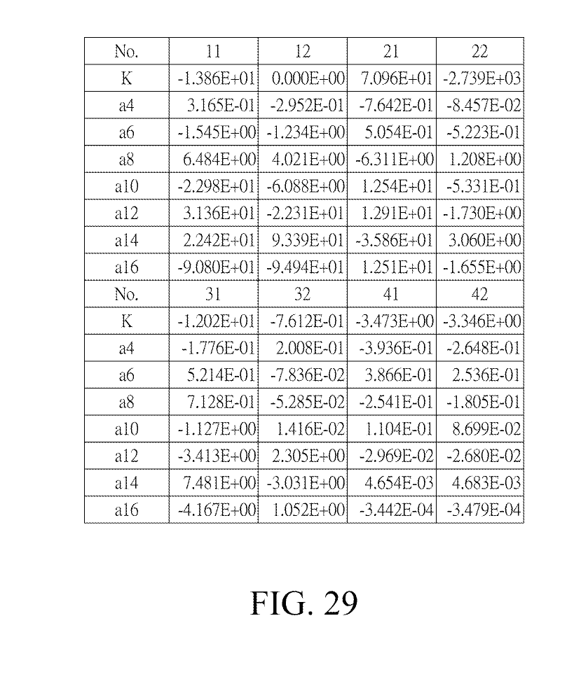

Please refer to FIG. 7 which illustrates the fourth example of the optical imaging lens set 1 of the present invention. Please refer to FIG. 8A for the longitudinal spherical aberration on the image plane 71 of the second example; please refer to FIG. 8B for the astigmatic aberration on the sagittal direction; please refer to FIG. 8C for the astigmatic aberration on the tangential direction, and please refer to FIG. 8D for the distortion aberration. The fourth example is similar with the first example except: the image-side surface 22 of the second lens element 20 has a concave part 26′ (concave optical axis part) in the vicinity of the optical axis and a convex part 27′ (convex circular periphery part) in a vicinity of its circular periphery, the object-side surface 31 of the third lens element 30 is a concave surface and has a concave portion 34′ (concave circular periphery part) in a vicinity of its circular periphery, and the object-side surface 41 of the fourth lens element 40 has a convex part 43 (convex optical axis part) in the vicinity of the optical axis, another convex part 44′ (convex circular periphery part) in a vicinity of its circular periphery and a concave part 45 between the optical axis and the circular periphery part. The optical data of the fourth example of the optical imaging lens set are shown in FIG. 28 while the aspheric surface data are shown in FIG. 29. The length of the optical imaging lens set is 3.401 mm. The image height is 2.270 mm. Some important ratios of the fourth example are as follows:

### Tₐₗₗ=1.634

### Gₐₐ=0.507

### BFL=1.260

### (G₁₂/G₂₃)=1.820

### (T₃/T₄)=1.553

### (BFL/G₂₃)=9.423

### (T₄/G₂₃)=2.705

### (T₃/Gₐₐ)=1.108

### (BFL/T₄)=3.484

### (Tₐₗₗ/G₂₃)=12.225

### (BFL/G₃₄)=9.692

### (BFL/G₁₂)=5.177

### (T₃/T₁)=1.221

### (T₁/T₄)=1.272

### (T₂/G₁₂)=1.032

### (T₁/T₂)=1.831

### Fifth Example

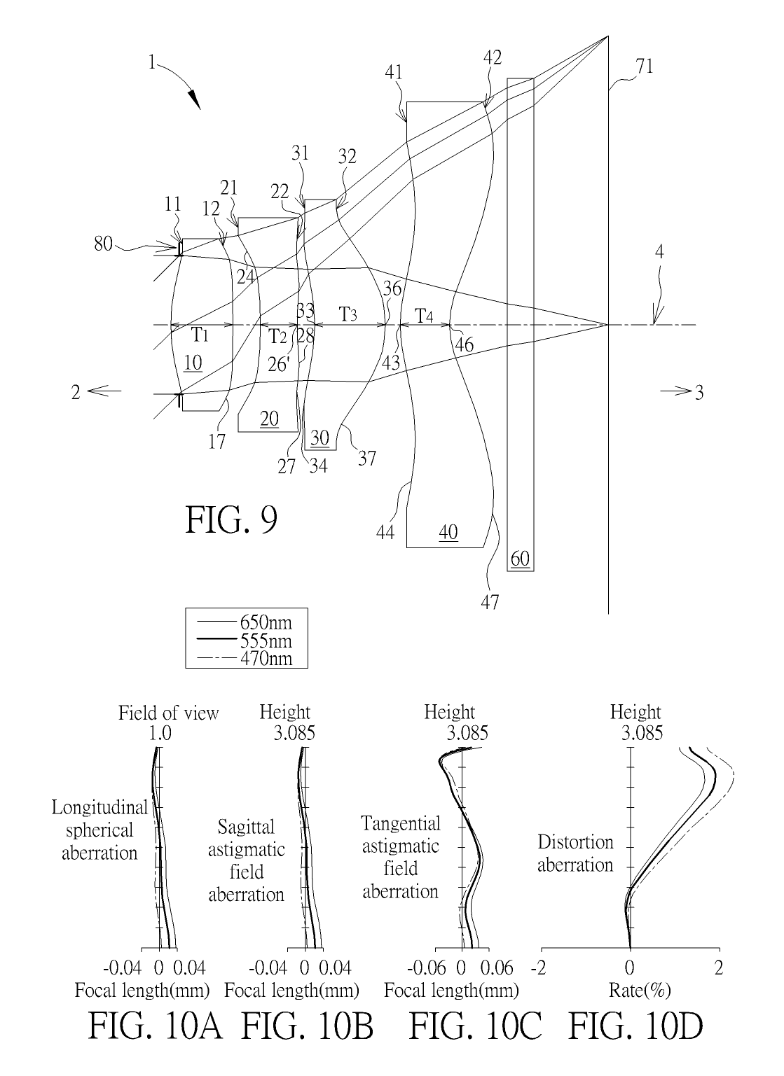

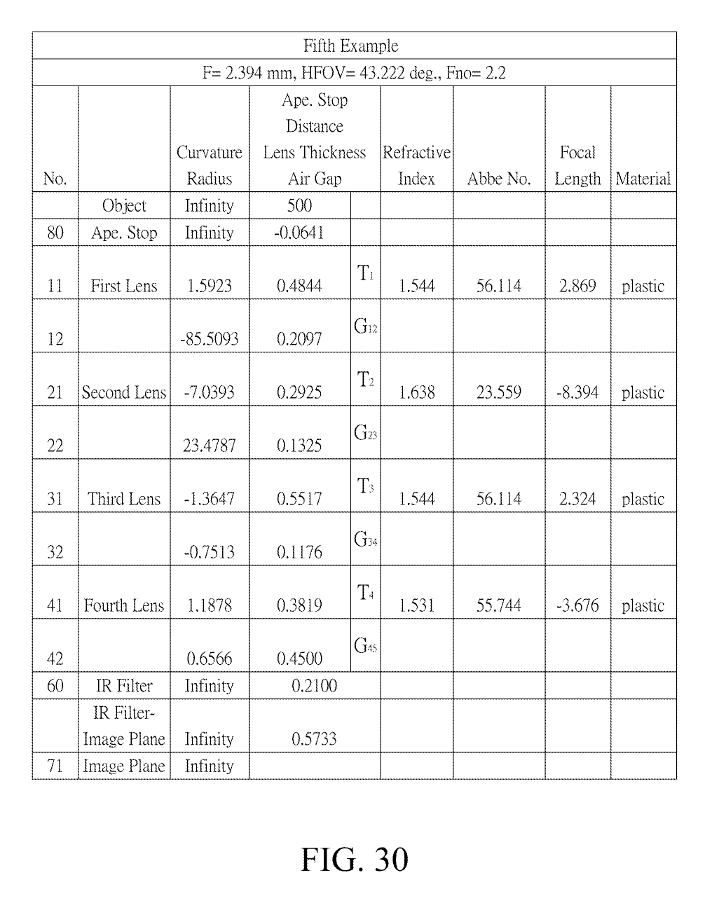

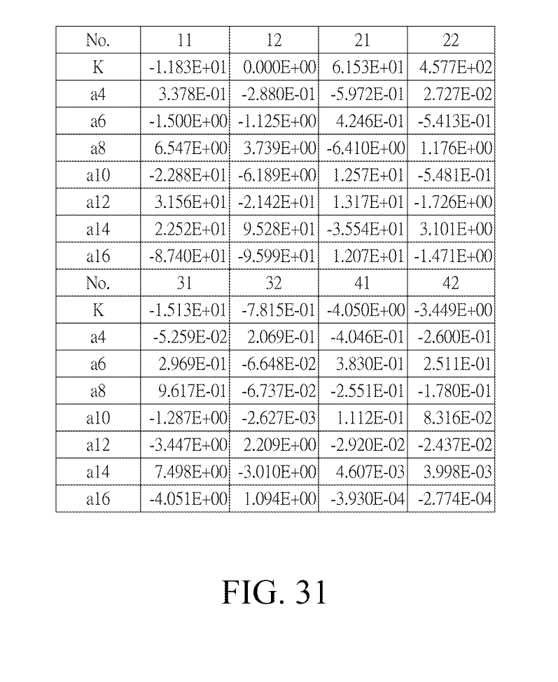

Please refer to FIG. 9 which illustrates the fifth example of the optical imaging lens set 1 of the present invention. Please refer to FIG. 10A for the longitudinal spherical aberration on the image plane 71 of the second example; please refer to FIG. 10B for the astigmatic aberration on the sagittal direction; please refer to FIG. 10C for the astigmatic aberration on the tangential direction, and please refer to FIG. 10D for the distortion aberration. The fifth example is similar with the first example except: the image-side surface 22 of the second lens element 20 has a concave part 26′ (concave optical axis part) in the vicinity of the optical axis, another concave part 27 (concave circular periphery part) in a vicinity of its circular periphery and a convex part 28 between the circular periphery and the optical axis. The optical data of the fifth example of the optical imaging lens set are shown in FIG. 30 while the aspheric surface data are shown in FIG. 31. The length of the optical imaging lens set is 3.404 mm. The image height is 2.270 mm. Some important ratios of the fifth example are as follows:

### Tₐₗₗ=1.711

### Gₐₐ=0.460

### BFL=1.233

### (G₁₂/G₂₃)=1.583

### (T₃/T₄)=1.445

### (BFL/G₂₃)=9.306

### (T₄/G₂₃)=2.882

### (T₃/Gₐₐ)=1.200

### (BFL/T₄)=3.229

### (Tₐₗₗ/G₂₃)=12.908

### (BFL/G₃₄)=10.488

### (BFL/G₁₂)=5.881

### (T₃/T₁)=1.139

### (T₁/T₄)=1.268

### (T₂/G₁₂)=1.395

### (T₁/T₂)=1.656

### Sixth Example

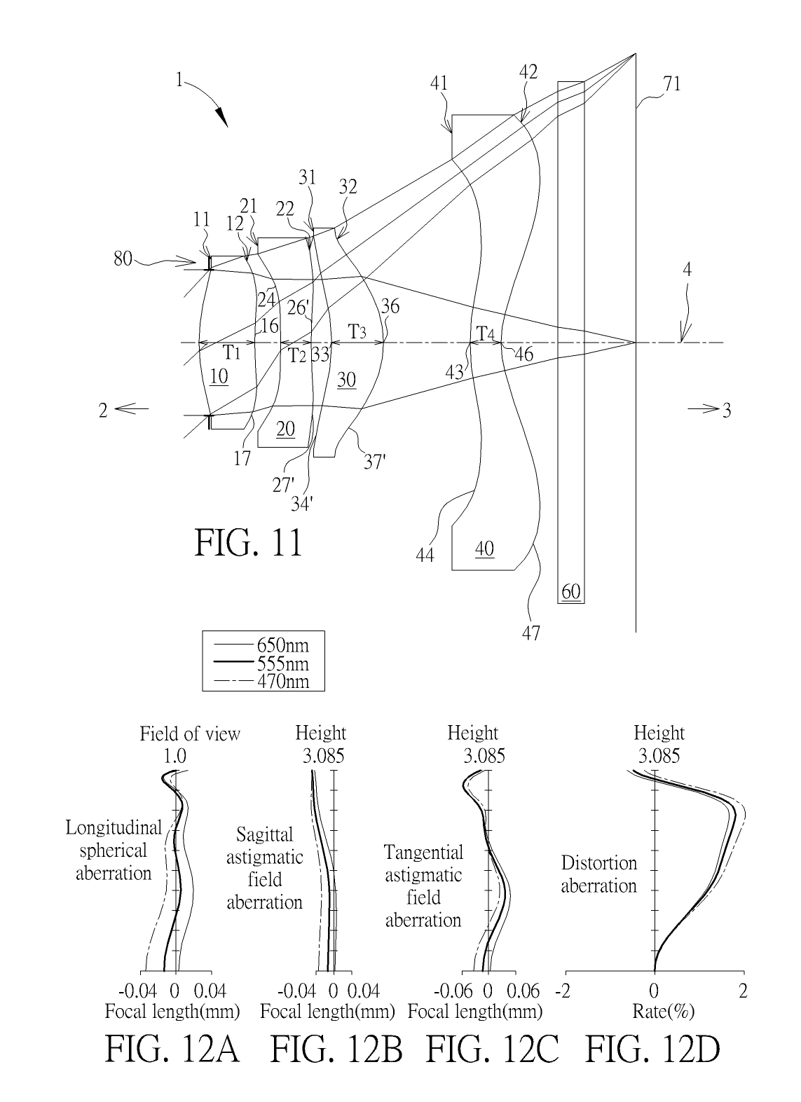

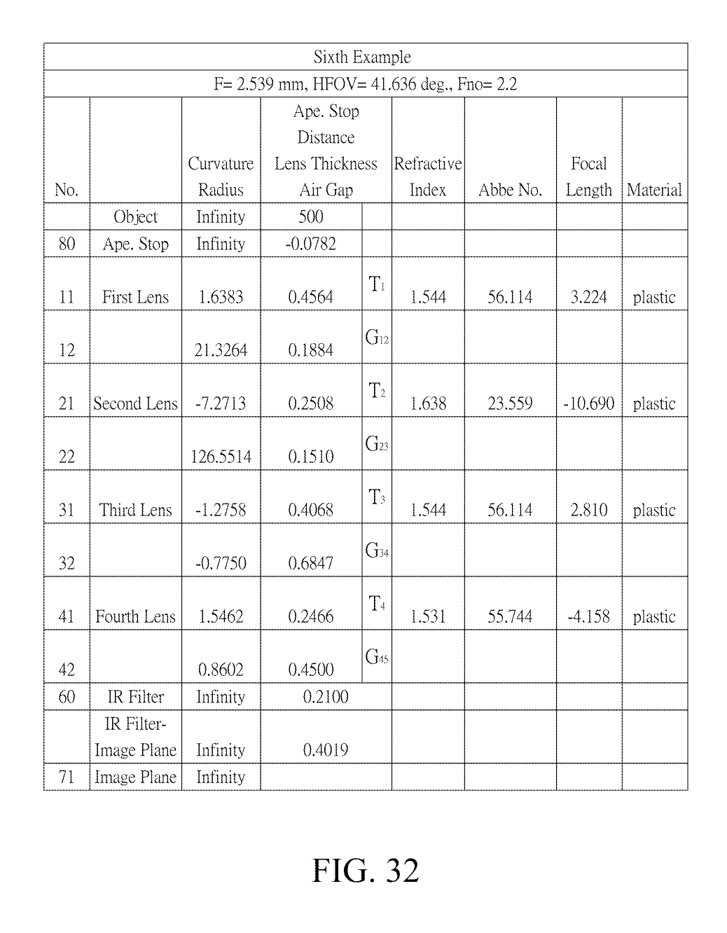

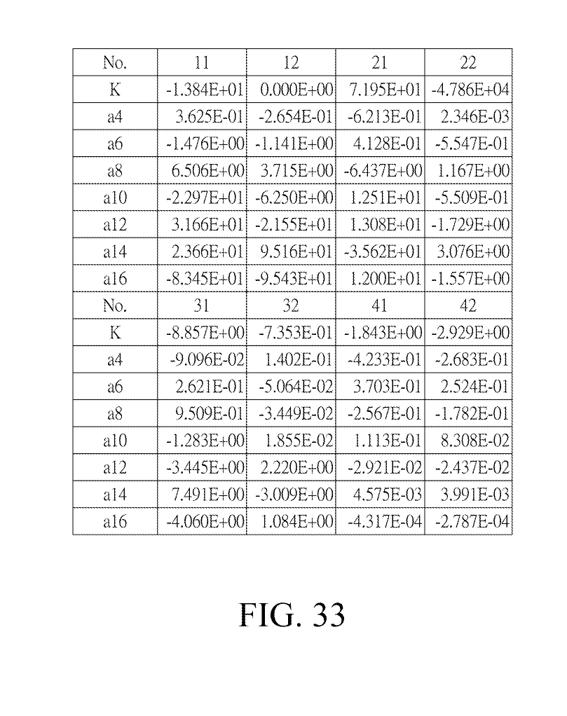

Please refer to FIG. 11 which illustrates the sixth example of the optical imaging lens set 1 of the present invention. Please refer to FIG. 12A for the longitudinal spherical aberration on the image plane 71 of the second example; please refer to FIG. 12B for the astigmatic aberration on the sagittal direction; please refer to FIG. 12C for the astigmatic aberration on the tangential direction, and please refer to FIG. 12D for the distortion aberration. The sixth example is similar with the first example except: the image-side surface 12 of the first lens element 10 has a concave part 16 (concave optical axis part) in the vicinity of the optical axis, the image-side surface 22 of the second lens element 20 has a concave part 26′ (concave optical axis part) in the vicinity of the optical axis and a convex part 27′ (convex circular periphery part) in a vicinity of its circular periphery, the object-side surface 31 of the third lens element 30 is a concave surface and has a concave portion 34′ (concave circular periphery part) in a vicinity of its circular periphery, and the image-side surface 32 of the third lens element 30 is a convex surface and has a convex portion 37′ (concave circular periphery part) in a vicinity of its circular periphery. The optical data of the sixth example of the optical imaging lens set are shown in FIG. 32 while the aspheric surface data are shown in FIG. 33. The length of the optical imaging lens set is 3.447 mm. The image height is 2.270 mm. Some important ratios of the sixth example are as follows:

### Tₐₗₗ=1.361

### Gₐₐ=1.024

### BFL=1.062

### (G₁₂/G₂₃)=1.248

### (T₃/T₄)=1.650

### (BFL/G₂₃)=7.034

### (T₄/G₂₃)=1.633

### (T₃/Gₐₐ)=0.397

### (BFL/T₄)=4.307

### (Tₐₗₗ/G₂₃)=9.013

### (BFL/G₃₄)=1.551

### (BFL/G₁₂)=5.636

### (T₃/T₁)=0.891

### (T₁/T₄)=1.851

### (T₂/G₁₂)=1.331

### (T₁/T₂)=1.820

### Seventh Example

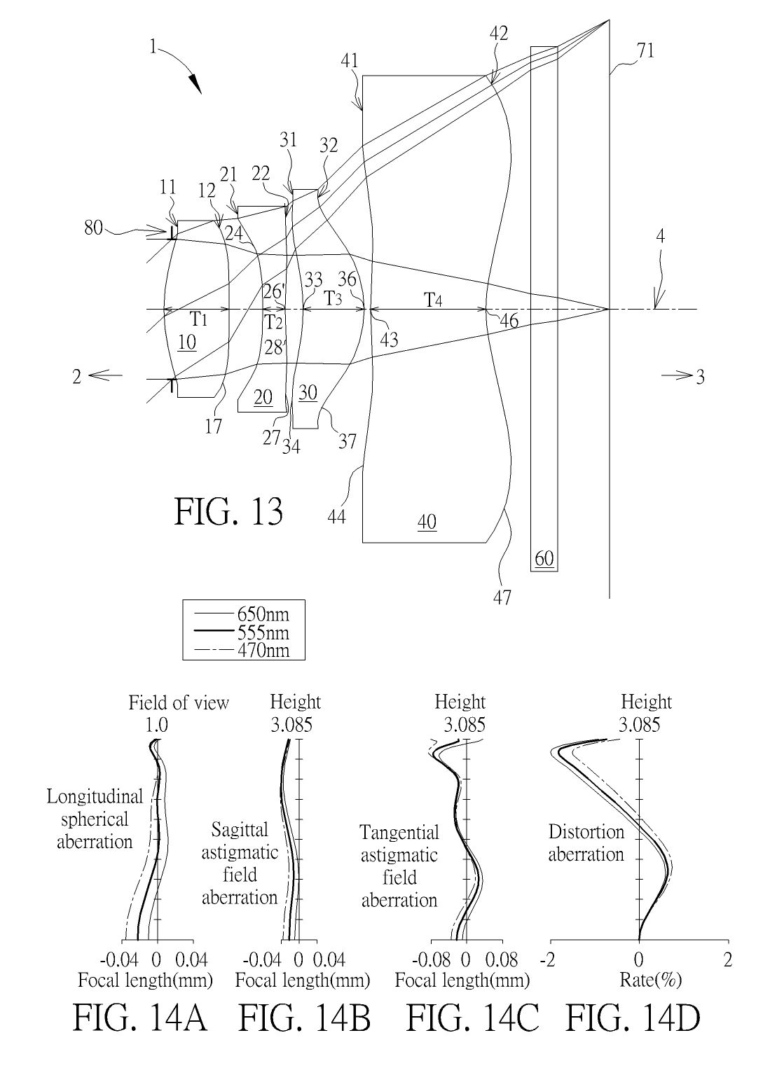

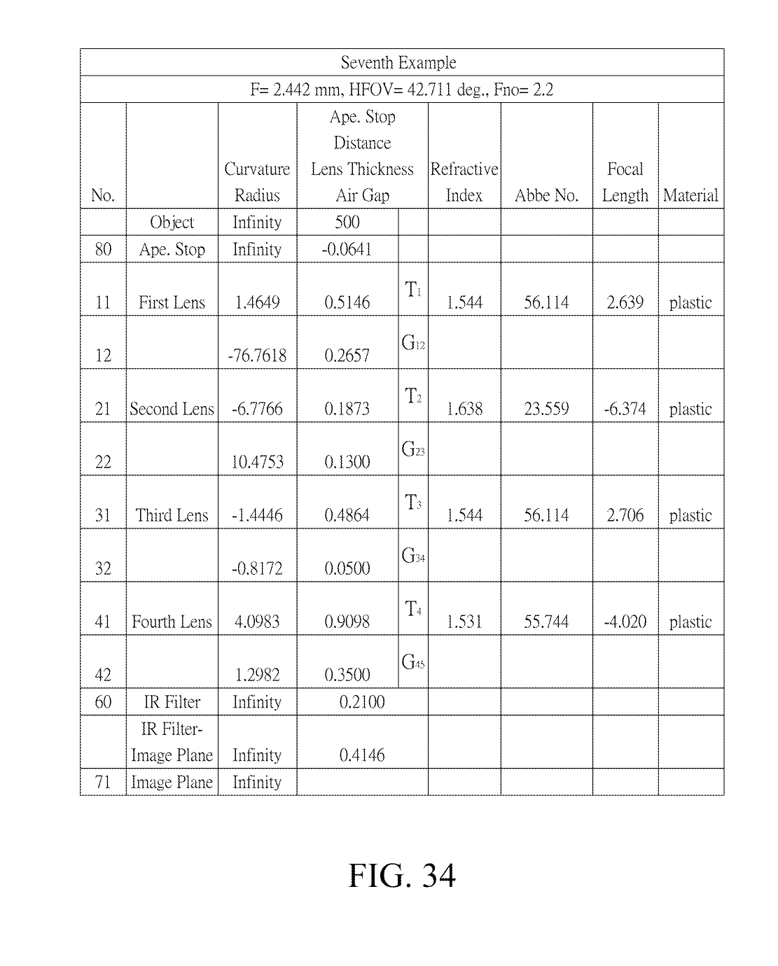

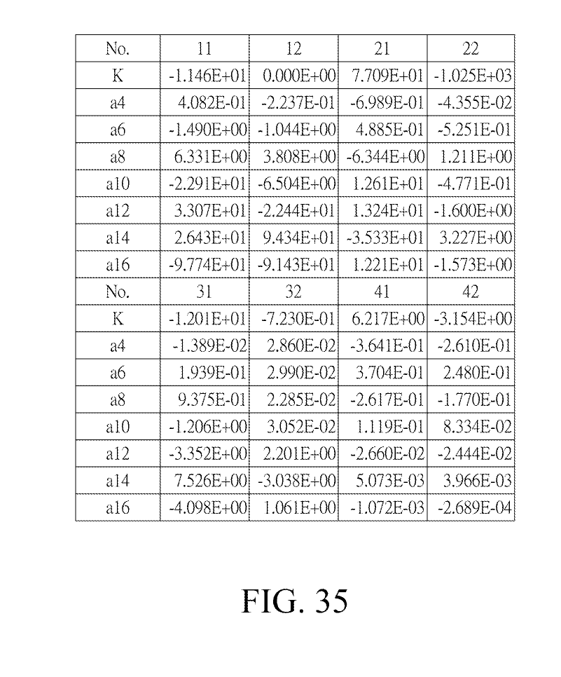

Please refer to FIG. 13 which illustrates the seventh example of the optical imaging lens set 1 of the present invention. Please refer to FIG. 14A for the longitudinal spherical aberration on the image plane 71 of the second example; please refer to FIG. 14B for the astigmatic aberration on the sagittal direction; please refer to FIG. 14C for the astigmatic aberration on the tangential direction, and please refer to FIG. 14D for the distortion aberration. The seventh example is similar with the first example except: the image-side surface 22 of the second lens element 20 has a concave part 26′ (concave optical axis part) in the vicinity of the optical axis, another concave part 27 (concave circular periphery part) in a vicinity of its circular periphery and a convex part 28 between the circular periphery and the optical axis. The optical data of the seventh example of the optical imaging lens set are shown in FIG. 34 while the aspheric surface data are shown in FIG. 35. The length of the optical imaging lens set is 3.518 mm. The image height is 2.270 mm. Some important ratios of the sixth example are as follows:

### Tₐₗₗ=2.098

### Gₐₐ=0.446

### BFL=0.975

### (G₁₂/G₂₃)=2.044

### (T₃/T₄)=0.535

### (BFL/G₂₃)=7.497

### (T₄/G₂₃)=6.999

### (T₃/Gₐₐ)=1.091

### (BFL/T₄)=1.071

### (Tₐₗₗ/G₂₃)=16.139

### (BFL/G₃₄)=19.492

### (BFL/G₁₂)=3.668

### (T₃/T₁)=0.945

### (T₁/T₄)=0.566

### (T₂/G₁₂)=0.705

### (T₁/T₂)=2.747

### Eighth Example

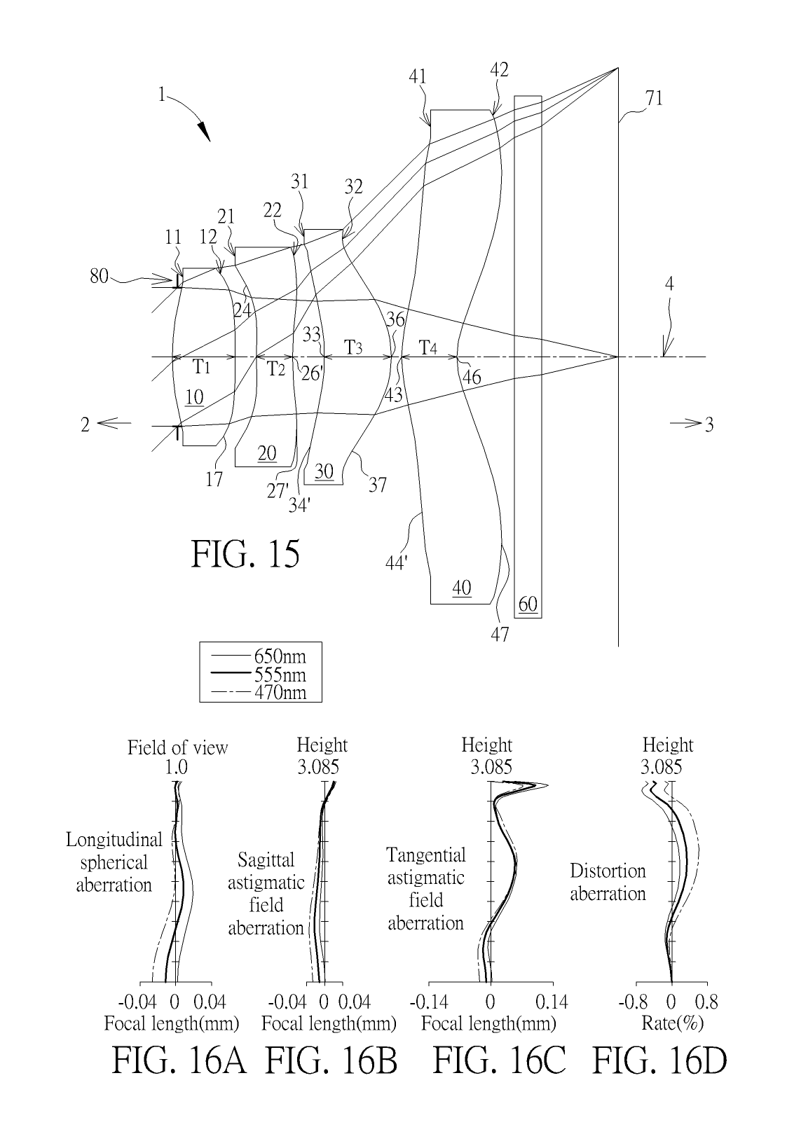

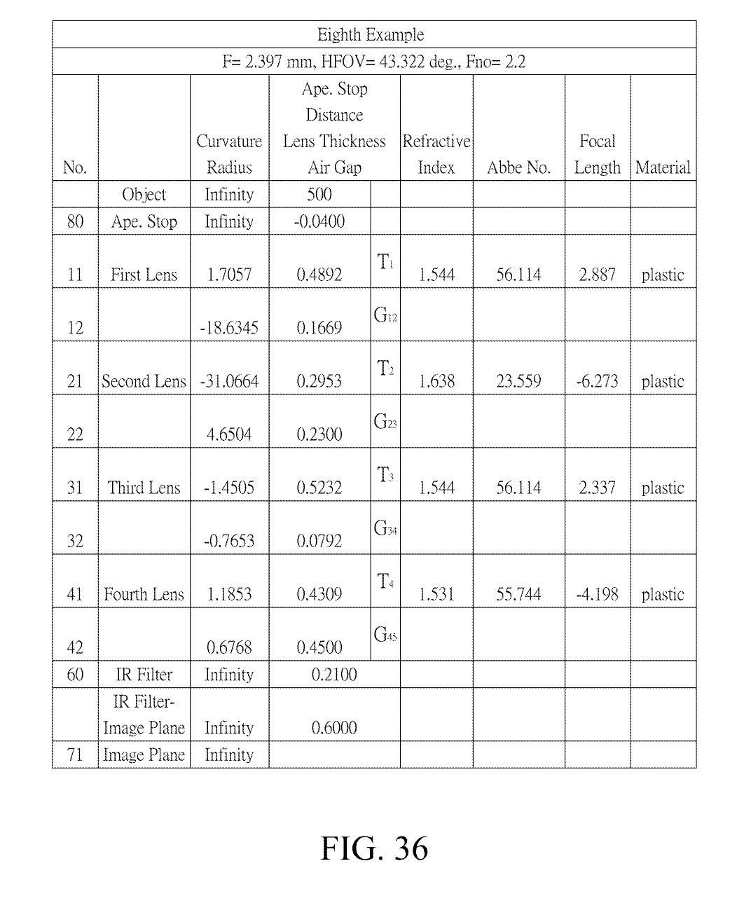

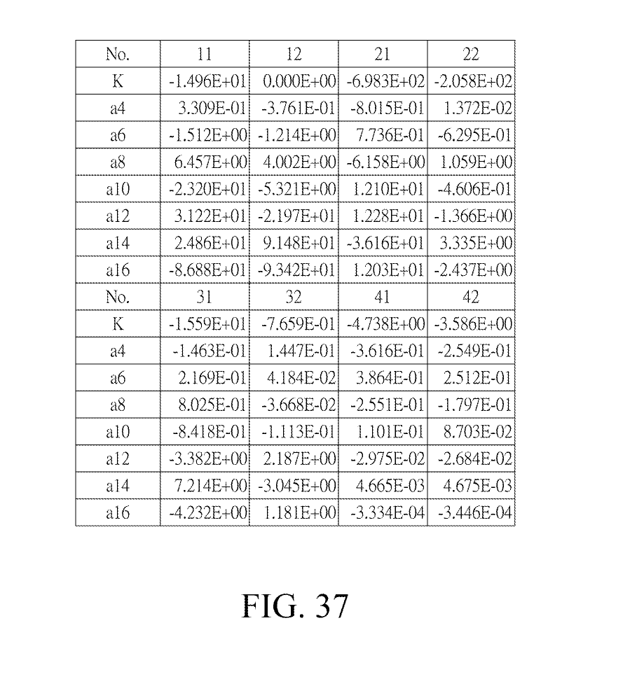

Please refer to FIG. 15 which illustrates the eighth example of the optical imaging lens set 1 of the present invention. Please refer to FIG. 16A for the longitudinal spherical aberration on the image plane 71 of the second example; please refer to FIG. 16B for the astigmatic aberration on the sagittal direction; please refer to FIG. 16C for the astigmatic aberration on the tangential direction, and please refer to FIG. 16D for the distortion aberration. The eighth example is similar with the first example except: the image-side surface 22 of the second lens element 20 has a concave part 26′ (concave optical axis part) in the vicinity of the optical axis, a convex part 27′ (convex circular periphery part) in a vicinity of its circular periphery, the object-side surface 31 of the third lens element 30 is a concave surface and has a concave portion 34′ (concave circular periphery part) in a vicinity of its circular periphery, and the object-side surface 41 of the fourth lens element 40 is a convex surface and has a convex part 44′ (convex circular periphery part) in a vicinity of its circular periphery. The optical data of the eighth example of the optical imaging lens set are shown in FIG. 36 while the aspheric surface data are shown in FIG. 37. The length of the optical imaging lens set is 3.475 mm. The image height is 2.270 mm. Some important ratios of the third example are as follows:

### Tₐₗₗ=1.739

### Gₐₐ=0.476

### BFL=1.260

### (G₁₂/G₂₃)=0.726

### (T₃/T₄)=1.214

### (BFL/G₂₃)=5.478

### (T₄/G₂₃)=1.874

### (T₃/Gₐₐ)=1.099

### (BFL/T₄)=2.924

### (Tₐₗₗ/G₂₃)=7.559

### (BFL/G₃₄)=15.915

### (BFL/G₁₂)=7.551

### (T₃/T₁)=1.070

### (T₁/T₄)=1.135

### (T₂/G₁₂)=1.770

### (T₁/T₂)=1.657

### Ninth Example

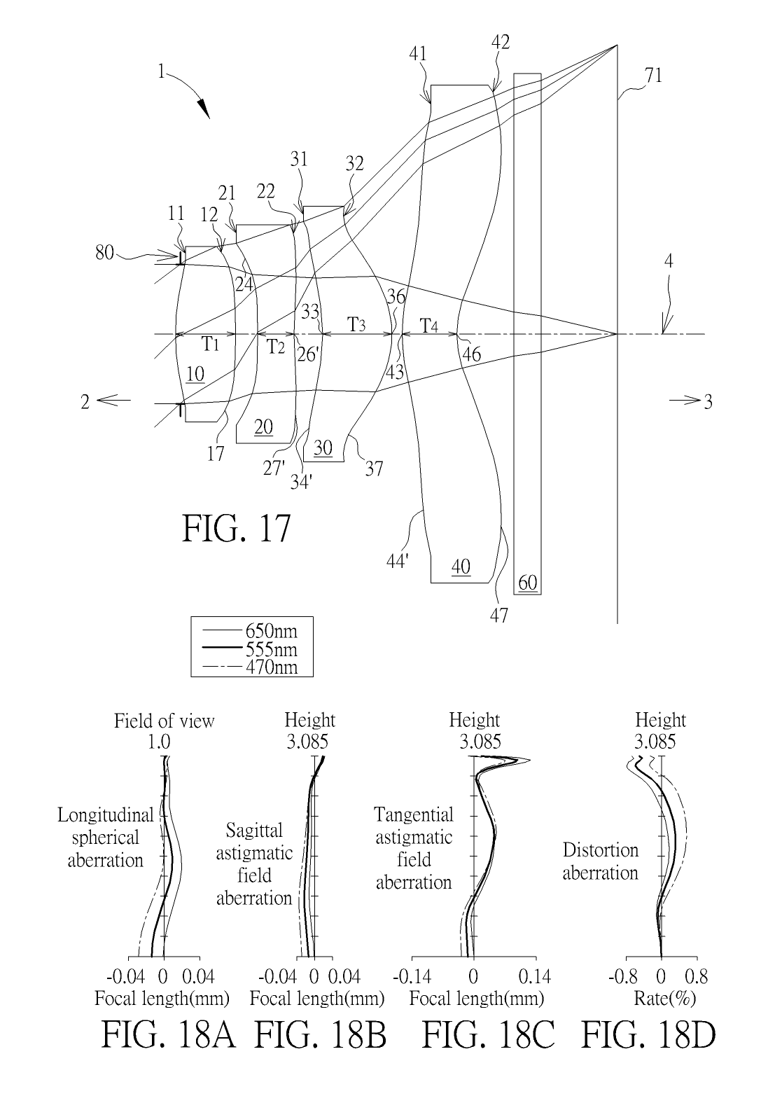

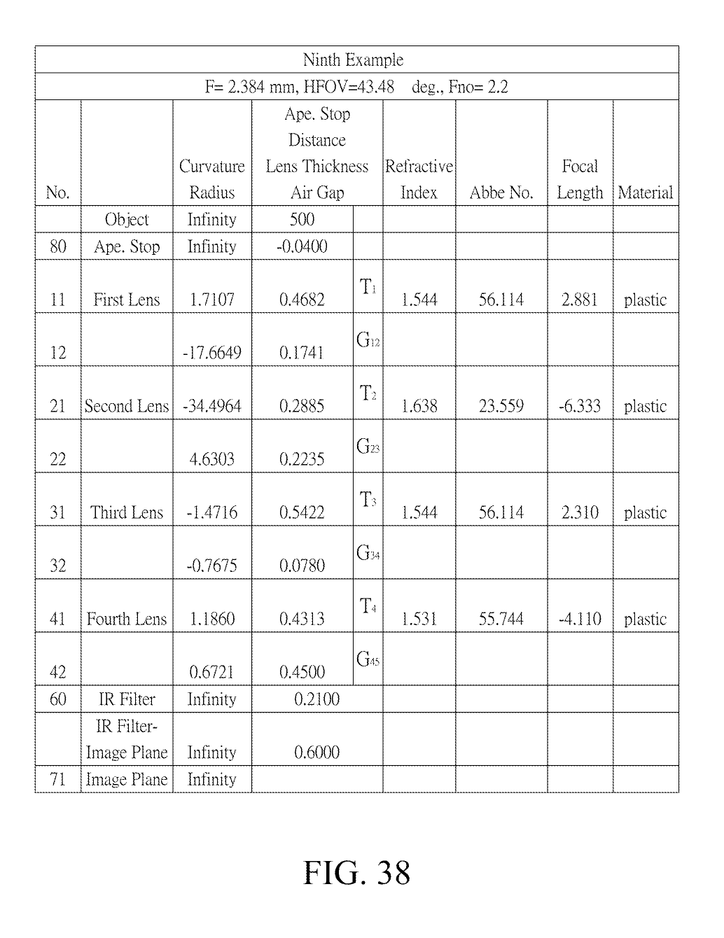

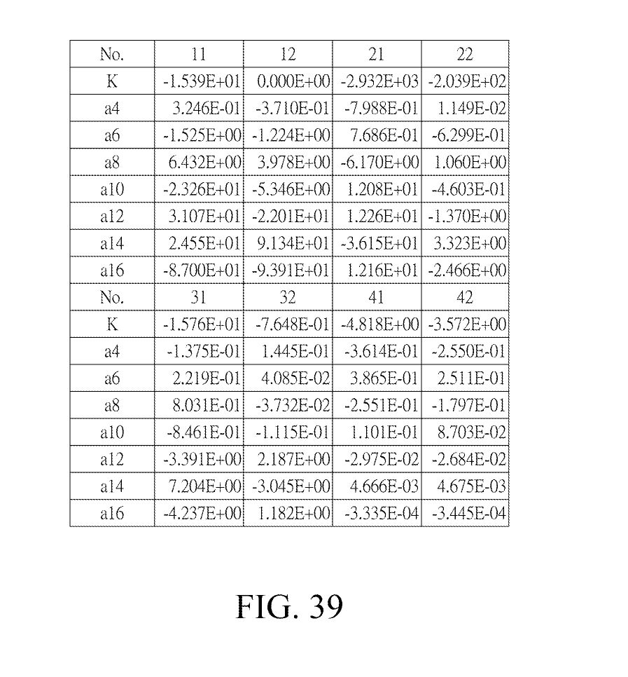

Please refer to FIG. 17 which illustrates the ninth example of the optical imaging lens set 1 of the present invention. Please refer to FIG. 18A for the longitudinal spherical aberration on the image plane 71 of the second example; please refer to FIG. 18B for the astigmatic aberration on the sagittal direction; please refer to FIG. 18C for the astigmatic aberration on the tangential direction, and please refer to FIG. 18D for the distortion aberration. The ninth example is similar with the first example except: the image-side surface 22 of the second lens element 20 has a concave part 26′ (concave optical axis part) in the vicinity of the optical axis and a convex part 27′ (convex circular periphery part) in a vicinity of its circular periphery, the object-side surface 31 of the third lens element 30 is a concave surface and has a concave portion 34′ (concave circular periphery part) in a vicinity of its circular periphery, and the object-side surface 41 of the fourth lens element 40 is a convex surface and has a convex part 44′ (convex circular periphery part) in a vicinity of its circular periphery. The optical data of the ninth example of the optical imaging lens set are shown in FIG. 38 while the aspheric surface data are shown in FIG. 39. The length of the optical imaging lens set is 3.466 mm. The image height is 2.270 mm. Some important ratios of the third example are as follows:

### Tₐₗₗ=1.730

### Gₐₐ=0.476

### BFL=1.260

### (G₁₂/G₂₃)=0.779

### (T₃/T₄)=1.257

### (BFL/G₂₃)=5.637

### (T₄/G₂₃)=1.929

### (T₃/Gₐₐ)=1.140

### (BFL/T₄)=2.921

### (Tₐₗₗ/G₂₃)=7.741

### (BFL/G₃₄)=16.155

### (BFL/G₁₂)=7.237

### (T₃/T₁)=1.158

### (T₁/T₄)=1.086

### (T₂/G₁₂)=1.657

### (T₁/T₂)=1.623

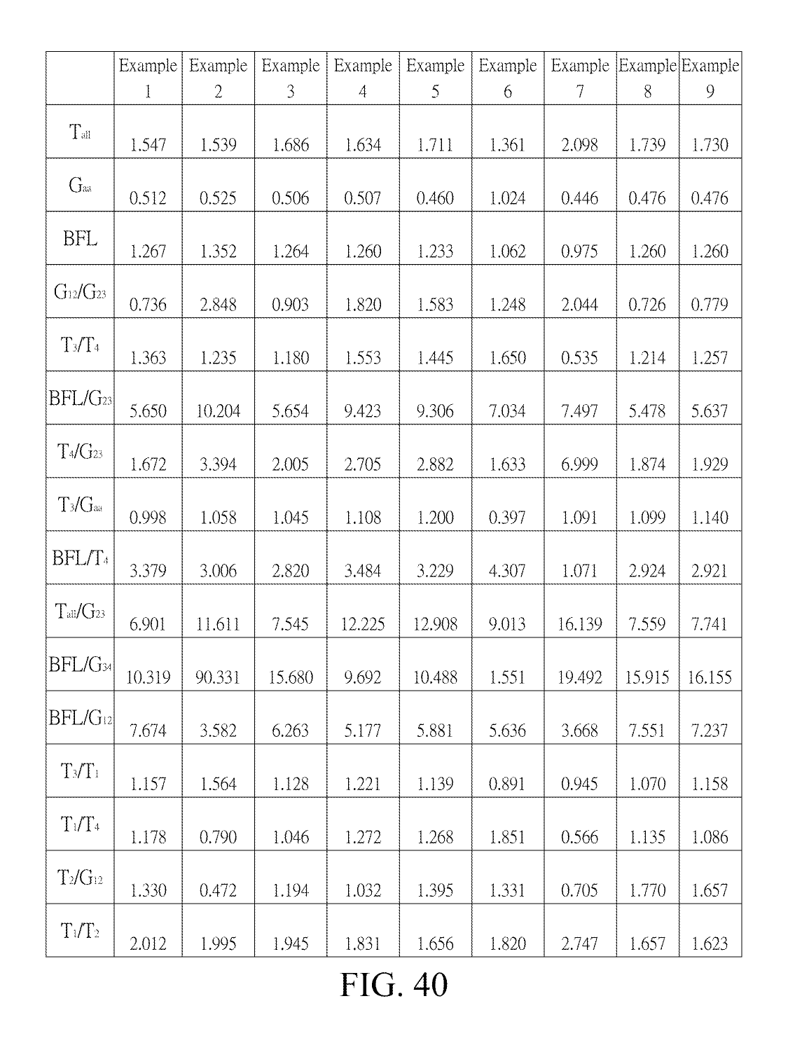

Some important ratios in each example are shown in FIG. 40.

In the light of the above examples, the inventors observe the following features:

1) The positive refractive power of the first lens element provides the refractive power of the entire optical imaging lens set 1, the negative refractive power of the second lens element helps to minimize the aberrations, the positive refractive power of the third lens element helps the contributions of the refractive power of the entire optical imaging lens set 1 to reduce the difficulties of the design and of the fabrication of the optical imaging lens set.
2) The convex surface of the object-side surface of the first lens element helps to collect the image light, the convex portion of the image-side surface of the first lens element, the concave portion in a vicinity of its circular periphery of the object-side surface of the second lens element, the concave portion in a vicinity of the optical axis of the object-side surface of the third lens element, the convex portion in a vicinity of the optical axis of the image-side surface of the third lens element, and the convex part in the vicinity of the optical axis of the object-side surface of the fourth lens element, the concave portion in a vicinity of the optical axis of the image-side surface and the convex part in the vicinity of the circular periphery may work together to enhance the imaging quality.

Given the above, the design and combination of the lens elements of the present invention result in excellent image quality.

In addition, it is found that there are some better ratio ranges for different optical data according to the above various important ratios. Better ratio ranges help the designers to design the better optical performance and an effectively reduced length of a practically possible optical imaging lens set. For example:

1. G₁₂/G₂₃ should be between 0.5 and 3.0. G₁₂ and G₂₃ each is the air gap between the first lens element 10 and the second lens element 20 or the second lens element 20 and the third lens element 30. The ratio is preferable between 0.5 and 3.0. A larger gap may increase the length of the lens set and a smaller gap may increase the difficulty of the assembly of the lens set.
2. T₃/T₄ is preferably not greater than 1.65, T₃/T₁ is preferably not less than 1.1, T₁/T₄ is preferably not greater than 1.45, T₁/T₂ is preferably greater than 1.6. T₁ to T₄ is the thickness of each lens element. They should be not too large or too small. It is suggested that T₃/T₄ is preferably not greater than 1.65, more preferably between 0.5˜1.65; T₃/T₁ is preferably not less than 1.1, more preferably between 1.1˜2.0; T₁/T₄ is preferably not greater than 1.45, more preferably between 0.5˜1.45; T₁/T₂ is preferably greater than 1.6, more preferably between 1.6˜3.0.
3. BFL/G₂₃ is preferably not less than 5.6, BFL/G₁₂ is preferably not less than 5.6, and BFL/T₄ is preferably not less than 2.6. BFL is the back focal length of the optical imaging lens set, namely a distance from the fourth image-side surface to an image plane along the optical axis. This BFL is bounded to the specification of the products or the thickness of the IR cut filter so it is not very flexible. However, it is possible to reduce G₁₂, G₂₃, T₄ to decrease the total length. It is suggested that BFL/G₂₃ is preferably not less than 5.6, more preferably between 5.6˜11.0; BFL/G₁₂ is preferably not less than 5.6, more preferably between 5.6˜9.0; and BFL/T₄ is preferably not less than 2.6, more preferably between 2.6˜5.0.
4. BFL/G₃₄ is preferably not greater than 18.0. BFL is as described above not very flexible. In order to avoid assembly inconvenience due to a too small G₃₄, G₃₄ should keep an ideal range without becoming too small. It is suggested that BFL/G₃₄ is preferably not greater than 18.0, more preferably between 8.0˜18.0.
5. T₄/G₂₃ is preferably not greater than 7.0, Tₐₗₗ/G₂₃ is preferably not greater than 9.5, T₃/Gₐₐ is preferably not greater than 1.2, and T₂/G₁₂ is preferably not greater than 1.78. G₁₂ and G₂₃ may be reduced as described above to obtain a shorter total length. When they are smaller, the corresponding thickness or the total lens element thickness, such as T₂, T₃, T₄, Tₐₗₗ should keep an ideal range. It is suggested that T₄/G₂₃ is preferably not greater than 7.0, more preferably between 1.0˜7.0; Tₐₗₗ/G₂₃ is preferably not greater than 9.5, more preferably between 5.0˜9.5; T₃/Gₐₐ is preferably not greater than 1.2, more preferably between 0.3˜1.2; T₂/G₁₂ is preferably not greater than 1.78, more preferably between 0.4˜1.78.

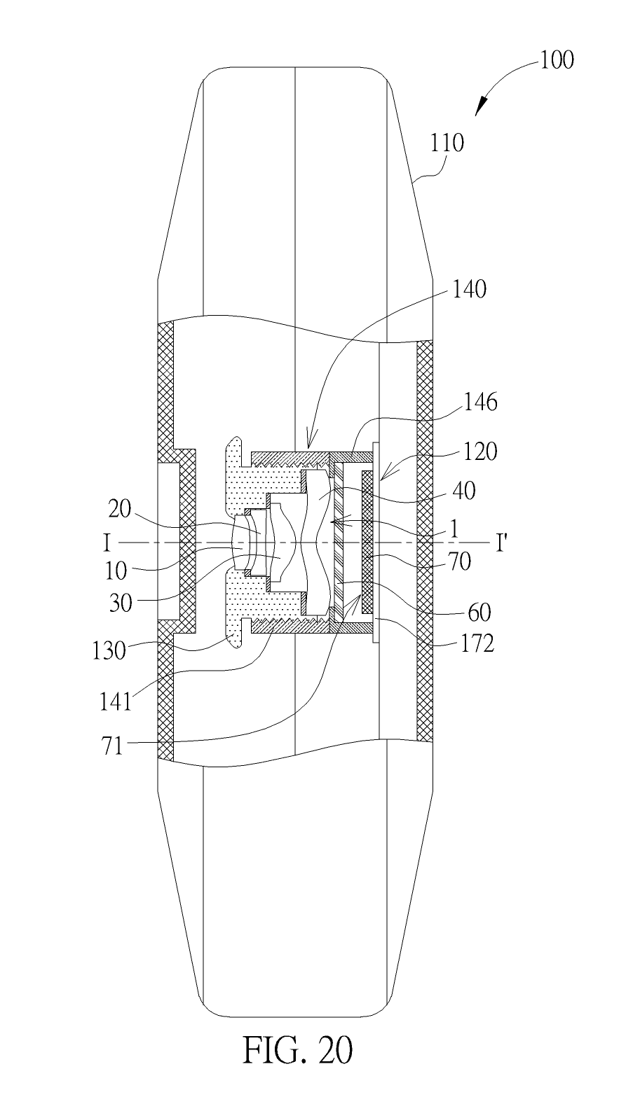

The optical imaging lens set 1 of the present invention may be applied to a portable electronic device. Please refer to FIG. 20. FIG. 20 illustrates a first preferred example of the optical imaging lens set 1 of the present invention for use in a portable electronic device 100. The portable electronic device 100 includes a case 110, and an image module 120 mounted in the case 110. A mobile phone is illustrated in FIG. 20 as an example, but the portable electronic device 100 is not limited to a mobile phone.

As shown in FIG. 20, the image module 120 includes the optical imaging lens set 1 as described above. FIG. 20 illustrates the aforementioned first example of the optical imaging lens set 1. In addition, the portable electronic device 100 also contains a barrel 130 for the installation of the optical imaging lens set 1, a module housing unit 140 for the installation of the barrel 130, a substrate 172 for the installation of the module housing unit 140 and an image sensor 70 disposed at the substrate 172, and at the image side 3 of the optical imaging lens set 1. The image sensor 70 in the optical imaging lens set 1 may be an electronic photosensitive element, such as a charge coupled device or a complementary metal oxide semiconductor element. The image plane 71 forms at the image sensor 70.

The image sensor 70 used here is a product of chip on board (COB) package rather than a product of the conventional chip scale package (CSP) so it is directly attached to the substrate 172, and protective glass is not needed in front of the image sensor 70 in the optical imaging lens set 1, but the present invention is not limited to this.

To be noticed in particular, the optional filter 60 may be omitted in other examples although the optional filter 60 is present in this example. The case 110, the barrel 130, and/or the module housing unit 140 may be a single element or consist of a plurality of elements, but the present invention is not limited to this.

Each one of the four lens elements 10, 20, 30 and 40 with refractive power is installed in the barrel 130 with air gaps disposed between two adjacent lens elements in an exemplary way. The module housing unit 140 has a lens element housing 141, and an image sensor housing 146 installed between the lens element housing 141 and the image sensor 70. However in other examples, the image sensor housing 146 is optional. The barrel 130 is installed coaxially along with the lens element housing 141 along the axis I-I′, and the barrel 130 is provided inside of the lens element housing 141.

Because the optical imaging lens set 1 of the present invention may be as short as 3.5 mm, this ideal length allows the dimensions and the size of the portable electronic device 100 to be smaller and lighter, but excellent optical performance and image quality are still possible. In such a way, the various examples of the present invention satisfy the need for economic benefits of using less raw materials in addition to satisfy the trend for a smaller and lighter product design and consumers' demands.

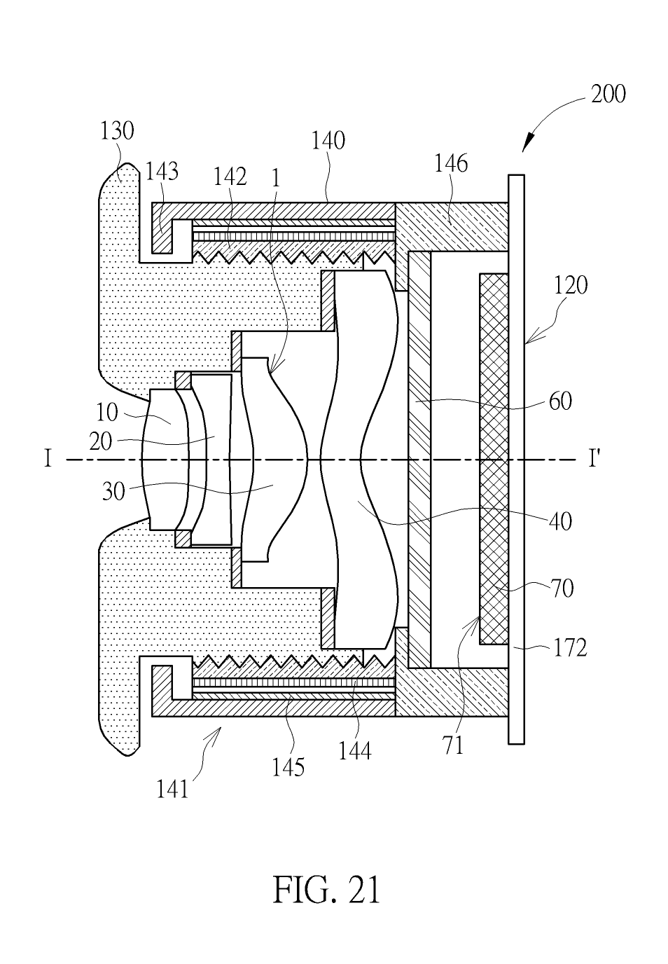

Please also refer to FIG. 21 for another application of the aforementioned optical imaging lens set 1 in a portable electronic device 200 in the second preferred example. The main differences between the portable electronic device 200 in the second preferred example and the portable electronic device 100 in the first preferred example are: the lens element housing 141 has a first seat element 142, a second seat element 143, a coil 144 and a magnetic component 145. The first seat element 142 is for the installation of the barrel 130, exteriorly attached to the barrel 130 and disposed along the axis I-I′. The second seat element 143 is disposed along the axis I-I′ and surrounds the exterior of the first seat element 142. The coil 144 is provided between the outside of the first seat element 142 and the inside of the second seat element 143. The magnetic component 145 is disposed between the outside of the coil 144 and the inside of the second seat element 143.

The first seat element 142 may pull the barrel 130 and the optical imaging lens set 1 which is disposed inside of the barrel 130 to move along the axis I-I′, namely the optical axis 4 in FIG. 1. The image sensor housing 146 is attached to the second seat element 143. The filter 60, such as an infrared filter, is installed at the image sensor housing 146. Other details of the portable electronic device 200 in the second preferred example are similar to those of the portable electronic device 100 in the first preferred example so they are not elaborated again.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. An optical imaging lens set, from an object side toward an image side in order along an optical axis comprising: an aperture stop, a first lens element, a second lens element, a third lens element and a fourth lens element and each lens element having refractive power, wherein:
said first lens element has positive refractive power, a first object-side surface facing toward said object side and a first image-side surface facing toward said image side, and said first object-side surface is a convex surface and the first image-side surface has a convex portion in a vicinity of a circular periphery of said first lens element;
said second lens element has negative refractive power, a second object-side surface facing toward said object-side and said second object-side surface has a concave portion in a vicinity of a circular periphery of said second lens element;
said third lens element has positive refractive power, a third object-side surface facing toward said object side and a third image-side surface facing toward said image side, and said third object-side surface has a concave portion in a vicinity of said optical axis and said third image-side surface has a convex portion in a vicinity of said optical axis; and
said fourth lens element has a fourth object-side surface facing toward said object side and a fourth image-side surface facing toward said image side, and said fourth object-side surface has a convex portion in a vicinity of said optical axis and said fourth image-side surface has a concave portion in a vicinity of said optical axis and a convex portion in a vicinity of a circular periphery of said fourth lens element,
wherein said optical imaging lens set exclusively has four lens elements with refractive power, an air gap G₁₂ between said first lens element and said second lens element along said optical axis, an air gap G₂₃ between said second lens element and said third lens element along said optical axis, an air gap G₃₄ between said third lens element and said fourth lens element along said optical axis, a sum of three air gaps Gₐₐ between each lens element from said first lens element to said fourth lens element along the optical axis, a thickness T₁ of said first lens element along said optical axis, a thickness T₂ of said second lens element along said optical axis, thickness T₃ of said third lens element along said optical axis and a thickness T₄ of said fourth lens element along said optical axis, a total thickness Tₐₗₗ of said first lens element, said second lens element, said third lens element and said fourth lens element along said optical axis and a back focal length (BFL) from said fourth image-side surface to an image plane satisfy 0.5≦(G₁₂/G₂₃)≦3.0.

2. The optical imaging lens set of claim 1, wherein (T₃/T₄)≦1.65.

3. The optical imaging lens set of claim 2, wherein 5.6≦(BFL/G₂₃).

4. The optical imaging lens set of claim 3, wherein (T₄/G₂₃)≦7.

5. The optical imaging lens set of claim 4, wherein 2.6≦(BFL/T₄).

6. The optical imaging lens set of claim 3, wherein (Tₐₗₗ/G₂₃)≦9.5.

7. The optical imaging lens set of claim 2, wherein (T₃/Gₐₐ)≦1.2.

8. The optical imaging lens set of claim 7, wherein (BFL/G₃₄)≦18.

9. The optical imaging lens set of claim 8, wherein 2.6≦(BFL/T₄).

10. The optical imaging lens set of claim 1, wherein 5.6≦(BFL/G₂₃).

11. The optical imaging lens set of claim 10, wherein (T₃/Gₐₐ)≦1.2.

12. The optical imaging lens set of claim 11, wherein 5.6≦(BFL/G₁₂).

13. The optical imaging lens set of claim 11, wherein 1.1≦(T₃/T₁).

14. The optical imaging lens set of claim 1, wherein (T₃/Gₐₐ)≦1.2.

15. The optical imaging lens set of claim 14, wherein (T₁/T₄)≦1.45.

16. The optical imaging lens set of claim 15, wherein (T₂/G₁₂)≦1.78.

17. The optical imaging lens set of claim 16, wherein 1.6≦(T₁/T₂).

18. An electronic device, comprising:
a case; and
an image module disposed in said case and comprising:
an optical imaging lens set of claim 1;
a barrel for the installation of said optical imaging lens set;
a module housing unit for the installation of said barrel;
a substrate for the installation of said module housing unit; and
an image sensor disposed at an image side of said optical imaging lens set.
